(19) United States
(12) Patent Application Publication
(10) Pub. No.: US 2006/0089285 A1
(43) Pub. Date: Apr. 27, 2006

(54) Stabilized chlorine bleach in alkaline detergent composition and method of making and using the same

(76) Inventors: Fahim U. Ahmed, Greensboro, NC (US); N. Camelia Traistaru, Gladstone, MO (US)

Correspondence Address: Hovey Williams LLP, Suite 400, 2405 Grand Blvd., Kansas City, MO, 64108, US

(21) Appl. No.: 10/970,218

(22) Filed: Oct. 21, 2004

(51) Int. Cl. C11D 3/00

(52) U.S. Cl. 510/370

(57) ABSTRACT

Liquid, shelf-stable alkaline cleaning compositions with chlorine bleach comprising a chlorine bleach capable of forming a hypochlorite in water, a bleach stabilizer selected from the group consisting of compounds having at least one NH— or NH₂— moiety capable of reacting with the hypochlorite to form NCl—, NHCl— or NCl₂— compounds, and from about 5-50% by weight of a metal hydroxide. Compositions according to the present invention are highly alkaline preferably presenting a pH of at least about 11.5. The compositions provide sustained hypochlorite bleach functionality and long term bleach stability even in the presence of surfactants. The bleach compositions are useful in cleaning and sanitizing household, institutional, and industrial hard surfaces including clean-in-place systems and food processing equipment.

### BACKGROUND OF THE INVENTION

1. Field of the Invention

The present invention generally concerns a highly alkaline, stabilized chlorine bleach detergent composition comprising a chlorine bleach, a bleach stabilizer and a metal hydroxide. The bleach stabilizer inhibits the degradation or decomposition of the available chlorine present in the detergent over time, thereby providing a bleach composition having an enhanced shelf-life.

2. Description of the Prior Art

Chlorine or hypochlorite bleaches have been used since the late 18th century as supplements to cleaning and sanitizing activities. Presently, chlorine and hypochlorite bleaches are used primarily as additives to household laundry processes, automatic dishwashing detergents and in some institutional and industrial detergents as performance boosters and sanitizing agents. Significant amounts of chlorine bleach are also used in hard surface cleaning and sanitizing, either in a separate step of the cleaning task or as an ingredient incorporated into the cleaning product.

Sodium hypochlorite (NaOCl) is the most common “chlorine” bleach used in laundry processing. Sodium hypochlorite solutions are commercially made by the reaction shown below using liquid chlorine and a solution of sodium hydroxide under cool temperatures.
2NaOH+Cl₂→NaOCl+NaCl+H₂O

Small amounts of free caustic (NaOH) or soda ash (Na₂CO₃) may be used to buffer the finished product to a desired pH level. The NaCl by-product is generally not removed, thereby adding to the total ionic strength and specific gravity of the solution. The strength of a hypochlorite bleach solution is generally characterized by its “available chlorine” content, which is a chemical convention for expressing the electron transfer capacity of the oxidizing chemical. The hypochlorite ion accepts two electrons in its conversion to a chloride. Therefore, the “available chlorine” equivalency is calculated as twice the actual weight % of the chlorine in the hypochlorite molecule. For example, in NaOCl, Cl equals 47.6% of the overall molecular weight (74.5). The available chlorine (on a molar basis), therefore, equals 95.2% of the molecular weight of the hypochlorite molecule.

Once formed, a number of factors can adversely impact the functionality and shelf stability of hypochlorite. The presence of metal ions, and exposure of the composition to heat and UV light can cause the hypochlorite to decompose. The decomposition of sodium hypochlorite can occur by two reaction paths. The total observed decomposition is the summation of both of the following reactions:
The Chlorate path:
   3 NaOCl→2 NaCl+NaClO₃
The Oxygen path:
   2 NaOCl→2 NaCl+O₂

The chlorate path is primarily associated with auto decompositions and will occur over time even under favorable storage conditions. It results from electron transfer reactions between the hypochlorite ions themselves. The net reaction results in no additional available chlorine. The oxygen path has been called the “catalyzed” decomposition route because it is most evident when oxidizable substances (e.g., organic substrates, organic soils, stains, metal ions in lower oxidation states) are present. This reaction is most notably indicated by a pressure build up in a tightly capped package due to the liberation of oxygen gas.

Hypochlorite also becomes more reactive and less shelf-stable as the acidity of the composition is increased due to the formation of HOCl.
OCl⁻+ [symbol] +HOCl
The pKa of this equilibrium is 7.5 at ambient temperature. The HOCl is much more reactive (unstable) than OCl⁻. Shifting the equilibrium in the direction of more HOCl formation is desirable for functional bleaching activity, but detrimental to shelf stability. At much higher acid concentrations, the hypochlorite becomes very reactive and unstable producing dangerous chlorine gas. Similarly, at highly alkaline conditions, the hypochlorite also becomes very unstable and decomposes rapidly to produce oxygen gas. The decomposition rates are also dependent on temperature and initial ionic strength. So in both highly acidic and highly alkaline conditions, the stability of the hypochlorite is in peril. In order to make products more marketable, cleaning performance is compromised by adjusting the pH and through the use of a buffering system.

Generally, the shelf stability of sodium hypochlorite bleach in an alkaline liquid detergent is relatively short, typically, about 3 months. Chorine bleach degrades rapidly due to many factors including the presence of trace amounts of di- and trivalent transition metals ions such as Ni, Co, Cu, and Fe etc., oxidizable organic compounds such as nonionic surfactants, pigments, dyes and perfumes, and exposure to heat and radiant energy such as ultra-violet light from sun. Extending the shelf storage stability of the chlorine bleach and maintaining bleach functionality in any environment is a daunting technical challenge, especially in a very highly alkaline detergent. Therefore, there is a real and unfulfilled need in the art for a chlorine bleach composition that exhibits improved bleach stability in highly alkaline detergents thereby avoiding production of hazardous chlorine gas while still providing excellent cleaning efficacy.

### SUMMARY OF THE INVENTION

The present invention overcomes the above problems by providing an alkaline liquid, shelf-stable, aqueous bleaching composition comprising a source of chlorine bleach compounds capable of forming a hypochlorite in water, a bleach stabilizer and a metal hydroxide. The stabilized hypochlorite compositions are typically singe-phase, homogeneous solutions, and as such are easily dispersible and convenient to dispense.

The chlorine bleach compound is preferably selected from the group consisting of alkali metal hypochlorites, alkaline earth metal hypochlorites, chlorine gas, hypochlorous acid, chlorine dioxide, N-chloro melamines, 1,3-dichloro-5,5-dimethylhydantoin, N-chlorosuccinimide, N-chloro-N-sodiobenzene sulfonamide, N-chloro hydantoins, N-chlorinated isocyanurates, N-chlorinated cyanuric acids, and combinations thereof, with sodium hypochlorite being most preferred. The bleaching compositions generally comprise from about 0.1-50% by weight of the hypochlorite salt, more preferably from about 0.545% by weight, and most preferably about 1-36% by weight. Preferably, the bleaching composition comprises sufficient quantities of chlorine bleach so as to provide from about 0.1-10% by weight available chlorine, more preferably from about 0.5-8% by weight, and most preferably from about 1-5% by weight. All weight percentages expressed herein are based on the weight of the entire composition unless otherwise stated.

The bleach stabilizer is preferably an N-Hydrogen compound selected from the group consisting of compounds having at least one NH— or NH₂— moiety capable of reacting with hypochlorite to form NCl—, NHCl—, or NCl₂— derivatives (or compounds). Preferably, the N-Hydrogen compound is a Brönsted acid amide which contains at least 1 N—H bond (i.e., an N—H or NH₂ group) adjacent to an electron withdrawing functional group such as C═O, S═O or P═O. Even more preferably, the N-Hydrogen compounds have dissociation constants (pKa) greater than 5 provided that the conjugate base of the Brönsted acid is not a halogen or halogen oxide. Particularly preferred stabilizer compounds are selected from the group consisting of sulfamic acids and the corresponding metal salts thereof (particularly water soluble salts such as sodium, potassium, magnesium, calcium, lithium and aluminum salts of sulfamic acid), alkyl sulfamates, cycloalkyl sulfamates, aryl sulfamates, alkyl sulfonamides, aryl sulfonamides, sulfamide, carbamate, methyl carbamate, methane sulfonamide, benzene sulfonamide, p-toluene sulfonamide, benzamide, phenyl sulfinimide, diphenyl sulfonamide, phenylsulfinimidylamide, diphenyl sulfonamide, dimethyl sulfinimidylamide, succinimide, acetamide, phthalimide, acetanilide, formamide, N-methylformamide, dicyanadiamide, N-ethylacetamide and 4-carboxybenzene sulfonamide, melamine, cyanamide, dicyanamide, ethyl carbamate, urea, thiourea, N-methylurea, N-methylolurea, acetylurea, isocyanuric acid, barbituric acid, 6-methyl uracil, glycoluril, caprolactum, dimethylhydantoin, imidazoline, pyrrolidone, pyrole, indole, orthophosphoryl triamide, phosphoryl triamide boric acid amide, and combinations thereof. Sulfamic acid is the most preferred bleach stabilizer. Generally, the chlorine bleach stabilizing agent is present in the bleaching composition in an amount sufficient to stabilize the chlorine bleach, preferably about 0.1-20% by weight, more preferably between about 1-15% by weight. Preferably, the chlorine stabilizing agent and chlorine bleach in compositions are in a molar ratio of 0.1:10 to 10:0.1; most preferably, one mole of chlorine bleach per mole of active hydrogen atom attached to the N-atom of the bleach stabilizer.

Preferred metal hydroxides for use with the present invention are alkali or alkaline earth metal hydroxides, with sodium and potassium hydroxides being most preferred. It is important that sufficient hydroxide be added so that the equilibrium reactions between the bleach stabilizer and chlorine bleach are shifted in favor of the formation of a compound containing a NCl—, NHCl—, or NCl₂— moiety. Preferably, the composition has a pH of at least about 11.5, more preferably of at least about 12, and most preferably between about 12.5-14. Preferably, the composition comprises between about 5-50% by weight metal hydroxide, more preferably between about 10-40% by weight, and most preferably between about 10-30% by weight.

Using sodium hypochlorite and sulfamic acid as the exemplary chlorine bleach and bleach stabilizer, it is believed that the following equations represent the equilibrium reactions for the stabilized chlorine bleach system:
NH₂—SO₃H+NaOCl [symbol] ClNH—SO₃H+NaOH→ClNH—SO₃Na+H₂O
ClNH—SO₃Na+NaOCl [symbol] Cl₂N—SO₃Na+NaOH
NH₂SO₃H+2NaOCl [symbol] Cl₂N—SO₃Na+NaOH+H₂O
The N-monochlorinated and N,N-dichlorinated sulfamates are obtained preferably by reacting an aqueous solution of one mole-equivalent of sulfamic acid or an alkali metal or an alkali earth metal sulfamate with an aqueous solution of up to 2 moles of hypochlorite. The above reactions proceed very rapidly by merely mixing the chemicals at ambient temperature. The first reaction step results in the formation of the N-monochlorosulfamate in quantitative yield by the reaction of equimolar amounts of sulfamate and hypochlorite ion. The second reaction step results in the conversion of part of the N-monochlorosulfamate obtained in the first step to N,N-dichlorosulfamate.

The equilibrium reaction of this bleach system favors the formation of N,N-dichlorosulfamate ions which decompose, relatively slowly, to yield under highly alkaline conditions (pH>11) nitrogen gas, sulfate, and chloride (1). If placed under acidic conditions, the N,N-dichlorosulfamate ions decompose by hydrolysis, to chlorine, chloramines, and sulfuric acid (2). In either case, the decomposition causes the system to become unstable.

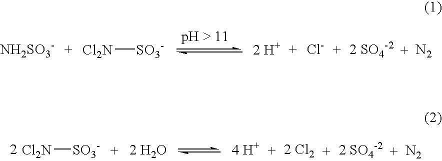

The highly alkaline system (i.e., pH>11) further enhances the stability of the N-halo compounds by neutralization of the acid (H⁺) produced on storage of the stabilized bleach composition. Throughout the foregoing, references have been made to the two different N-chlorosulfamate products: N-monochlorosulfamate, and N,N-dichlorosulfamate. In the description presented herein, the use of the term N-chlorosulfamates refers to a reaction mixture containing either or both of the foregoing products.

The stability of the bleaching compositions is achieved by maintaining, at a minimum, a stoichiometric ratio between the chlorine bleach and bleach stabilizer. Amounts of bleach stabilizer in excess of the corresponding stoichiometric quantity of bleach do not negatively impact the system. However, if an amount of bleach stabilizer less than the required stoichiometric amount is used, no system stability is achieved. Surprisingly, the presence of less than the stoichiometric amount of bleach stabilizer oftentimes produces a destabilizing effect, producing a system with inferior bleach stability than a system in which no bleach stabilizer is used. The precise molar ratio between bleach stabilizer and chlorine bleach depends entirely upon the nature of the stabilizer and its ability to react with chlorine. Table 1 illustrates the optimal theoretical mole ratios of hypochlorite to various bleach stabilizing N-Hydrogen compounds necessary to produce bleaching compositions having maximum stability at neutral pH.

TABLE 1

| Bleach Stabilizers | Mole Ratio (Stabilizer/OCl⁻) |
|---|---|
| Sulfamic Acid | 1:2 |
| Sulfamide | 1:4 |
| Trisulfamide | 1:3 |
| p-Toluenesulfonamide | 1:2 |
| Melamine | 1:6 |
| Sodium Triamidometaphosphate | 1:3 |
| 5,5-Dimethylhydantoin | 1:2 |

As shown for the bleach stabilizer compounds in Table 1, the preferred molar ratio of bleach stabilizer to chlorine bleach depends on the number of active hydrogen atoms attached to the N-atom of the stabilizer. For the compositions shown in Table 1, the preferred molar ratio of bleach stabilizer to chlorine bleach is at least about 1:6, more preferably at least about 1:3, and most preferably at least about 1:2. In preferred embodiments of the present invention, the bleach stabilizer and chlorine bleach are in a molar ratio of about 10:1 to 1:10, more preferably about 6:1 to 1:8, and most preferably about 1:1 to 1:6.

The stabilized bleaching compositions exhibit improved long term storage stability over a substantially identical composition employing no bleach stabilizer. Preferably, over a 8 month storage period at temperatures between about 20-60° C. (preferably at about 25° C.) compositions according to the present invention exhibit less than about a 60% loss of available chlorine at elevated temperatures and preferably less than a 35% loss at ambient (25° C.) conditions compared to the initial available chlorine content of the composition. More specifically, at ambient temperature the stabilized bleaching compositions showed a significant improvement of 35-59% in long term storage stability over the control where no stabilizer had been used. For storage at 40° C., the stabilized bleaching compositions showed an improvement of 82-100% over the control. Similarly, for storage at 50° C., an improvement of 100% over the control was achieved.

Compositions according to the present invention may also comprise several optional ingredients which impart desirable or beneficial characteristics to the composition such as water soluble builders, sequestrants, surface active agents, colorants, and fragrances.

Water soluble builders and sequestrants enhance cleaning performance of detergents especially in hard water wash conditions. Preferred builder salts include alkali metal detergent builder salts, particularly the alkali metal polyphosphates and phosphonates. Examples of these builder salts include, but are not limited to, alkali metal pyrophosphates (e.g., tetrasodium or tetrapostassium pyrophosphates), alkali metal tripolyphosphates (e.g., sodium or potassium tripolyphosphate, either anhydrous or hydrated), alkali metal metaphosphates (e.g., sodium or potassium hexametaphoshates), and the like (e.g., trisodium or tripotassium orthophosphate). The amount of alkali metal polyphosphate employed is preferably up to about 25% by weight of the composition, more preferably about 0-15% by weight.

Inorganic and organic non-phosphate detergent builder salts may also be used in the present detergent composition. Examples of preferred inorganic non-phosphate builder salts include alkali metal borates, carbonates and bicarbonates, and water insoluble aluminosilicates or zeolites, both crystalline and amorphous. More specific examples include sodium tetraborate, sodium carbonate, sodium bicarbonate, sodium sesquicarbonate, potassium carbonate, potassium bicarbonate, sodium and potassium zeolites. Exemplary organic non-phosphate builders and sequestrant salts include alkali metal salts of polycarboxylic acids and nitriloacetic acid. More specific examples include monosodium, disodium and trisodium citrate, and tetrasodium ethylenediaminetetraacetate (EDTA-Na₄). Mixtures of alkali polyphosphates and conventional organic and/or inorganic builder salts may also be employed. Since the compositions according to the present invention are generally concentrated and generally used in relatively small amounts, it is preferable to supplement the polyphosphates builder salts, such as sodium/potassium tripolyphosphates with an auxiliary builder such as an alkali metal polycarboxylate salt. Preferred alkali metal polycarboxylic salts include the alkali metal salts of citric acid and tartaric acid, with the sodium salt of citric acid being particularly preferred. Other auxiliary sequestrants such as the non-phosphate detergent builder salts may also be used to supplement any polyphosphate builder salt.

Low molecular weight non-cross linked polyacrylates having a molecular weight of about 1,000 to 100,000; more preferably about 2,000 to 80,000, most preferably about 4500 are optional sequestrants used in connection with the builder salts. Water soluble salts of acrylic acid and methacrylic acid homopolymers are particularly preferred for use with the present invention. The water soluble salts are preferably alkali metal salts such as potassium or sodium salts, ammonium salts, or substituted ammonium salt. The salt is also preferably in partially or fully neutralized form. Partial neutralization and esterification of the carboxylic acid groups may be performed while maintaining the efficacy of the homopolymer. Low molecular weight polyacrylates are commercially available such as the low molecular weight non-cross-linked ACUSOL polyacrylates available from Rohm and Hass. ACUSOL 445N, having a molecular weight of about 4,500 is particularly preferred.

A mixture of an acrylic acid homopolymer and a maleic/olefin copolymer may also be used as the non-cross-linked polyacrylate. The copolymer may be derived from a substituted or unsubstituted maleic anhydride and a lower olefin in place of all or a portion of the cyclic anhydride. Preferably, the maleic anhydride monomer is of the general formula: 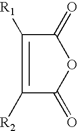
Where R₁ and R₂ are each independently selected from the group consisting of H, (C₁-C₄) alkyl, phenyl, C₁-C₄ alkylphenyl or phenyl C₁-C₄ alkylene moieties; most preferably R₁ and R₂ are each H. The lower olefin component is preferably a C₁-C₄ olefin, such as ethylene, propylene, isopropylene, butylenes or isobutylene, and most preferably ethylene. Preferably, these copolymers have a molecular weight from about 1000 to 100,000, and more preferably from about 1000 to 50,000. ACUSOL 460N is a preferred commercial copolymer having a molecular weight of about 15,000. Other exemplary copolymers include partially and fully neutralized copolymers of a methacrylic acid and maleic anhydride sodium salt. These water soluble non-cross-linked polyacrylate polymers and copolymers, either alone or in combination, preferably comprise up to about 20% by weight of the overall composition, and more preferably between about 1-10% by weight.

Preferably, the surface active agent used with the present invention is relatively stable in the presence of oxidants such as chlorine bleach, especially hypochlorite bleach. Preferred surface active agents are selected from the group consisting of anionic, nonionic, cationic and amphoteric surfactants, and mixtures thereof. Particularly preferred surface active agents include water soluble organic anionic surfactants, amine oxides, phosphine oxides, sulphoxides, sulfonates (especially DOWFAX linear or branched alkali metal mono-and/or di-(C₈-C₁₄) alkyl diphenyl oxide mono-and/or disulfonates available from Dow Chemical Company), sulfates, betaines, primary alkyl sulfates, alkyl sulfonates, arylalkylsulfonates and secondary alkylsulfonates. Exemplary anionic surfactants include sodium (C₁₀-C₁₈) alkylsulfonates such as sodium dodecylsulfonate, sodium alkylsulfonates such as sodium hexdecyl-1-sulfonate, and sodium (C₁₂-C₁₈) alkylbenzenesulfonates such as sodium dodecylbenzenesulfonate. The corresponding potassium salts of the foregoing are also acceptable.

Exemplary nonionic surfactants are high and low foam surfactants such as poly-lower alkoxylated higher alcohols in which the alcohol contains 9 to 18 carbon atoms and the number of moles of lower alkylene oxide (2 or 3 carbon atoms) is from 3 to 12. Exemplary nonionic surfactants useful with the present invention include the low foam PLURAFAC series from BASF Chemical Company. These surfactants are the reaction product of a higher linear alcohol and a mixture of propylene oxide and ethylene oxides, containing a mixed chain of propylene oxide and ethylene oxide terminated by a hydroxyl group. Specific examples include a C₁₃-C₁₅ fatty alcohol condensed with 6 moles of ethylene oxide and 3 moles of propylene oxide and a C₁₃-C₁₅ fatty alcohol condensed with 7 moles of propylene oxide and 4 moles of ethylene oxide. Particularly preferred Plurafac® surfactants include Plurafac® LF 132, Plurafac® LF 231, Plurafac® LF 303, Plurafac® LF 305, Plurafac® S 305LF, Plurafac® RA 40, Plurafac® RA 30, Plurafac® 25R2, Plurafac® SLF 18, and Plurafac® SLF 18B-45.

Other exemplary nonionic surfactants include condensation products of a mixture of higher fatty alcohols averaging about 12 to 15 carbon atoms with about 6.5 to 7 moles of ethylene oxide under the name NEODOL by Shell Chemical Company such as Neodol® 25-7 and Neodol® 25-6.5. Still further exemplary nonionic surfactants include linear secondary alcohol ethoxylates, and linear alcohols having randomly distributed ethoxy and propoxy groups sold under name TERGITOL by Union Carbide such as Tergitol® 15-S-7, Tergitol® 15-S-9, and Tergitol® MDS-42. The POLY-TERGENT family of low foaming, biodegradable alkoxylated liner fatty alcohols by Olin Corporation are also exemplary surfactants suitable for use with the present invention. Particularly preferred Poly-Tergent® surfactants include Poly-Tergent® S-LF 18, Ploy-Tergent® S-303-LF, Poly-Tergent® S-305-LF, Poly-Tergent® S-405-LF and CS-1.

Additional exemplary surfactants inlcude alkylpolysaccharide surfactants having a hydrophobic group containing about 8 to 20 carbon atoms. Preferably, these surfactants comprise about 10 to 16 carbon atoms (most preferably 12 to 14 carbon atoms) and about 1.5 to 10 saccharide units (e.g., fructosyl, glucosyl and galactosyl units). Exemplary surfactants suitable for use with the present invention include alkylpolysaccharide surfactants particularly those available from Henkel Corporation under name APG characterized by the general formula (CₙH₂ₙ₊₁)O(C₆H₁₀O₅)ₓH such as APG 625.

Preferably, compositions according to the present invention comprise up to about 6% by weight of a surface active agent, and more preferably up to about 3% by weight. It is important to note that it is within the scope of the invention to employ a mixture of two or more of the liquid surface active agents described above. Also, the inventive compositions can be used in high-foam, low-foam, and no-foam applications. The amount of foaming desired will generally dictate the choice of surfactant to be used.

Other ingredients such as perfume/fragrance, hydrotropic agents, preservatives, colorants and dyestuffs, pigments and the like may be incorporated into the inventive highly alkaline bleaching compositions provided that they are stable in a highly alkaline environment and in presence of chlorine bleach. The balance of the bleaching composition is water, preferably deionized water.

One particular advantage of the present invention is that organic fragrances and colorants that would otherwise be susceptible to oxidative degradation in the presence of chlorine bleach are surprisingly stable in the present compositions because the chlorine bleach is stabilized and bound.

The above-described compositions are generally regarded as concentrates capable of being diluted into use solutions prior to being used to clean a soiled surface. Preferably, about one part by weight of a concentrate composition as described above is combined with from about 1-500 parts by weight water (more preferably from about 25-100 parts by weight water) to form the use solution. Preferably, the use solutions have a pH of at least about 11.5, more preferably at least about 12, and most preferably from about 12-14.

The bleaching compositions and their respective use solutions are generally characterized by low viscosities, as opposed to highly viscous gel compositions. Preferably, the bleaching compositions and use solutions have Brookfield viscosities of less then about 2000 cps (at 25° C., 30 rpm), more preferably less than about 1000 cps, even more preferably less than about 500 cps, and most preferably less than about 50 cps.

Compositions according to the present invention, and particularly the use solutions thereof, are useful in cleaning a soiled surface, particularly a surface soiled with protein residues such as milk residue. Methods of cleaning in accordance with the invention comprise the steps of providing a bleaching and cleaning composition as set forth above and applying the composition to a surface. Preferably, the composition is diluted prior to application to the soiled surface to form a use solution as described above. During the dilution step, it is preferable for the water added to have a temperature between about 40-90° C. and more preferably between about 50-70° C. A water temperature in this range assists in releasing available chlorine from the bleach stabilized complex thereby enhancing the composition's cleaning power.

Methods according to the present invention are useful in cleaning and sanitizing any number of surfaces soiled with a variety of contaminants, particularly protein soils such as milk residue. Surfaces which are likely to contain these types of soils include food processing systems (such as milking equipment), clean-in-place systems, and industrial food processing units such as dairy, fish, poultry, meat, juice, beverage, cheese, and other food processing equipment. The concentrated bleaching compositions or use compositions may be applied to the surface to be cleaned in liquid form, as a spray, or as a foam. It is also preferable to adequately rinse the surface once cleaned so as to avoid contamination of food products with the bleaching compositions or use solutions.

### DETAILED DESCRIPTION OF THE PREFERRED EMBODIMENT

The following examples set forth preferred chlorine bleach stabilized alkaline detergents in accordance with the present invention. It is to be understood, however, that these examples are provided by way of illustration and nothing therein should be taken as a limitation upon the overall scope of the invention.

Five chloroalkaline liquid detergent formulas (I-V) were prepared and tested. Each detergent formula was evaluated using different chlorine levels and different sulfamic acid stabilizer levels. The stability of each formula was observed under ambient (25° C.), 40° C., and 50° C. conditions for up to 10 months.

The stabilized bleaching compositions showed a significant improvement of 30 to 53% in long term storage stability at ambient temperature over the control where no stabilizer was used. The stabilized bleaching compositions showed a very significant improvement of 60 to 100% in long term storage stability at 40° C. over the control where no stabilizer had been used. Similarly, the stabilized bleaching compositions exhibited superior stability at 50° C. storage temperature whereas the stabilizer-free control was depleted of chlorine in as early as 60 days resulting in a 100% improvement. Further, the stabilized bleach compositions provided sustained long term hypochlorite bleach functionality as demonstrated in the cleaning trials involving bleach-sensitive soils such as proteins from milk.

### Highly Alkaline Stabilized Liquid Detergent Composition I

In this example, highly alkaline stabilized detergent compositions (“Composition I”) with 4%, 3.5%, and 3% available chlorine, including some with adjusted alkalinity, were studied. Following each table summarizing the composition of each detergent, stability data for each detergent is shown at various storage temperatures: 25° C., 40° C., and/or 50° C. In the samples with adjusted alkalinity, additional sodium hydroxide was added to the compositions to neutralize the added sulfamic acid and to keep the alkalinity of the composition substantially the same in all of the compositions. The amount of additional sodium hydroxide need was based on potentiometric titration of the alkaline compositions containing sulfamic acid and chlorine bleach.

TABLE 2
Highly Alkaline Stabilized Detergent Composition I with 4% Available Chlorine

| Ingredients | I (1) | I (2) | I (3) | I (4) | I (5) | I (6) | I (7) | I (8) |
|---|---|---|---|---|---|---|---|---|
| Deionized Water | 20.90 | 23.60 | 24.90 | 26.30 | 27.60 | 29.00 | 30.30 | 31.70 |
| Sodium Polyacrylate (50%), Good Rite 7058 | 0.80 | 0.80 | 0.80 | 0.80 | 0.80 | 0.80 | 0.80 | 0.80 |
| 2-Phosphonobutane-1,2,4-Tricarboxylic Acid (50%) | 1.20 | 1.20 | 1.20 | 1.20 | 1.20 | 1.20 | 1.20 | 1.20 |
| NaOH (50%) | 33.30 | 33.30 | 33.30 | 33.30 | 33.30 | 33.30 | 33.30 | 33.30 |
| Sulfamic Acid | 10.80 | 8.10 | 6.80 | 5.40 | 4.10 | 2.70 | 1.40 | 0.00 |
| NaOCl (av. Cl 12.6%) | 33.00 | 33.00 | 33.00 | 33.00 | 33.00 | 33.00 | 33.00 | 33.00 |
| Mole Ratio: NH₂SO₃H/NaOCl | 1.00/1.0 | 0.75/1.0 | 0.63/1.0 | 0.50/1.0 | 0.38/1.0 | 0.25/1.0 | 0.13/1.0 | 0.00/1.0 |
| pH (Neat, 19.5° C.) | 13.90 | 13.89 | 13.90 | 13.91 | 13.90 | 13.90 | 13.90 | 13.91 |

TABLE 3
Bleach Stability Data at Different Temperature-Highly Alkaline Detergent Composition I with 4% Available Chlorine
Bleach Stability: 25° C.

| | | Days of Stability | | | | | | | | | | | | |
|---|---|---|---|---|---|---|---|---|---|---|---|---|---|---|
| | | 0 | 32 | 54 | 97 | 124 | 141 | 161 | 197 | 226 | 264 | 294 | 368 | |
| | % | % | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | Av. Cl | % Cl Lost |
| I (1) | 10.80 | 3.951 | 3.818 | 3.779 | 3.682 | — | — | — | — | — | — | — | — | — |
| I (2) | 8.10 | 3.930 | 3.818 | 3.778 | 3.694 | 3.628 | 3.616 | 3.594 | 3.518 | 3.505 | 3.426 | 3.447 | 3.455 | 12.09 |
| I (3) | 6.80 | 3.941 | 3.824 | 3.759 | 3.712 | 3.657 | 3.648 | 3.600 | 3.529 | 3.509 | 3.504 | 3.437 | 3.230 | 18.04 |
| I (4) | 5.40 | 3.921 | 3.828 | 3.786 | 3.686 | 3.600 | 3.595 | 3.587 | 3.514 | 3.506 | 3.409 | 3.386 | 2.985 | 23.87 |
| I (5) | 4.10 | 3.810 | 1.783 | 1.763 | 1.687 | 1.644 | 1.645 | 1.637 | 1.603 | 1.594 | 1.574 | 1.159 | 1.394 | 63.41 |
| I (6) | 2.70 | 3.794 | 0.901 | 0.594 | 0.373 | 0.282 | 0.245 | 0.197 | 0.165 | 0.126 | 0.100 | 0.104 | 0.115 | 96.97 |
| I (7) | 1.40 | 3.828 | 1.744 | 1.508 | 1.256 | — | — | — | — | — | — | — | — | — |
| I (8) | 0.00 | 3.945 | 3.178 | 2.865 | 2.38 | 2.145 | 2.028 | 1.884 | 1.644 | 1.527 | 1.347 | 1.259 | 0.974 | 75.31 |

Bleach Stability: 40° C.

| | | Days of Stability | | | | | | | | | | | | |
|---|---|---|---|---|---|---|---|---|---|---|---|---|---|---|
| | | 0 | 32 | 55 | 97 | 124 | 141 | 161 | 197 | 229 | 264 | 294 | 368 | |
| | % | % | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | Av. Cl | % Cl Lost |
| I (1) | 10.80 | 3.951 | 3.724 | 3.702 | 3.661 | — | — | — | — | — | — | — | — | — |
| I (2) | 8.10 | 3.930 | 3.716 | 3.625 | 3.555 | 3.516 | 3.499 | 3.444 | 3.361 | 3.326 | 3.252 | 3.179 | 3.067 | 21.96 |
| I (3) | 6.80 | 3.941 | 3.730 | 3.652 | 3.581 | 3.554 | 3.531 | 3.478 | 3.425 | 3.414 | 3.374 | 3.332 | 3.101 | 21.31 |
| I (4) | 5.40 | 3.921 | 3.669 | 3.621 | 3.521 | 3.516 | 3.477 | 3.446 | 3.439 | 3.415 | 3.405 | 3.339 | 3.256 | 16.96 |
| I (5) | 4.10 | 3.810 | 1.612 | 1.592 | 1.551 | 1.547 | 1.523 | 1.486 | 1.479 | 1.428 | 1.408 | 1.394 | 1.311 | 65.59 |
| I (6) | 2.70 | 3.794 | 0.082 | 0.062 | 0.051 | 0.051 | 0.055 | 0.055 | 0.057 | 0.007 | 0.046 | — | — | — |
| I (7) | 1.40 | 3.828 | 0.640 | 0.405 | 0.201 | — | — | — | — | — | — | — | — | — |
| I (8) | 0.00 | 3.945 | 1.052 | 0.621 | 0.272 | 0.154 | 0.113 | 0.029 | 0.007 | 0.000 | — | — | — | 100 |

Bleach Stability: 50° C.

| | | Days of Stability | | | | | | | | | | |
|---|---|---|---|---|---|---|---|---|---|---|---|---|
| | | 0 | 32 | 54 | 97 | 124 | 141 | 161 | 197 | 229 | 264 | |
| | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | Cl Lost, % |
| I (1) | | 3.951 | 3.760 | 3.667 | 3.573 | — | — | — | — | — | — | |
| I (2) | 8.10 | 3.930 | 3.217 | 3.048 | 2.721 | 2.467 | 2.231 | 2.055 | 1.337 | 1.274 | 0.264 | 8 |
| I (3) | 6.80 | 3.941 | 3.277 | 3.102 | 2.698 | 2.494 | 2.286 | 2.044 | 1.676 | 1.298 | 0.839 | 78.71 |
| I (4) | 5.40 | 3.921 | 3.151 | 2.923 | 2.650 | 2.426 | 2.306 | 2.081 | 1.900 | 1.459 | 1.041 | 73.45 |
| I (5) | 4.10 | 3.810 | 1.391 | 1.364 | 1.279 | 1.223 | 1.175 | 1.082 | 0.968 | 0.818 | 0.658 | 82.73 |
| I (6) | 2.70 | 3.794 | 0.070 | 0.050 | 0.000 | — | — | — | — | — | — | 100.00 |
| I (7) | 1.40 | 3.828 | 0.141 | 0.015 | 0.000 | — | — | — | — | — | — | 100.00 |
| I (8) | 0.00 | 3.945 | 0.129 | 0.010 | 0.000 | — | — | — | — | — | — | 100.00 |

TABLE 4
Highly Alkaline Stabilized Bleach Composition I with 3% Available Chlorine

| Ingredients | I (9) | I (10) | I (11) | I (12) | I (13) | I (14) | I (15) | I (16) |
|---|---|---|---|---|---|---|---|---|
| Deionized Water | 31.60 | 33.60 | 43.60 | 35.60 | 36.60 | 37.70 | 38.60 | 39.70 |
| Sodium Polyacrylate (50%), Good | 0.80 | 0.80 | 0.80 | 0.80 | 0.80 | 0.80 | 0.80 | 0.80 |
| Rite 7058 | | | | | | | | |
| 2-Phosphononobutane-1,2,4- | 1.20 | 1.20 | 1.20 | 1.20 | 1.20 | 1.20 | 1.20 | 1.20 |
| Tricarboxylic Acid (50%) | | | | | | | | |
| NaOH (50%) | 33.30 | 33.30 | 33.30 | 33.30 | 33.30 | 33.30 | 33.30 | 33.30 |
| Sulfamic Acid | 8.10 | 6.10 | 5.10 | 4.10 | 3.10 | 2.00 | 1.10 | 0.00 |
| NaOCl (Av. Cl. 12.00%) | 25.00 | 25.00 | 25.00 | 25.00 | 25.00 | 25.00 | 25.00 | 25.00 |
| Mole Ratio: NH₂SO₃H/NaOCl | 1.00/1.00 | 0.75/1.00 | 0.63/1.00 | 0.50/1.00 | 0.38/1.00 | 0.25/1.00 | 0.13/1.00 | 0.00/1.00 |
| pH (Neat, 24.8° C.) | 13.90 | 13.89 | 13.90 | 13.91 | 13.90 | 13.90 | 13.90 | 13.91 |
| pH, use solution (0.5% v/v, 22° C.) | — | 12.26 | — | 12.25 | — | — | — | 12.27 |
| Brookfield Viscosity, use solution | — | 4.54 | — | 4.60 | — | — | — | 4.06 |
| (UL Adapter, 25° C., 30 rpm), cps | | | | | | | | |

TABLE 5
Bleach Stability Data at Different Temperature-Highly Alkaline Stabilized Bleaching Composition I with 3% Available Chlorine
Bleach Stability: 25° C.

Days of Stability

| | | 0 | 39 | 53 | 70 | 88 | 108 | 137 | 179 | 210 | 229 | 309 | |
|---|---|---|---|---|---|---|---|---|---|---|---|---|---|
| Sam- | % | % | % | % | % | % | % | % | % | % | % | % | Improvement |
| ple | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| I (9) | 8.10 | 2.941 | 2.786 | — | — | — | — | — | — | — | — | — | — |
| I (10) | 6.10 | 2.930 | 2.777 | 2.764 | 2.724 | 2.701 | 2.675 | 2.606 | 2.595 | 2.574 | 2.534 | 2.497 | 14.78 |
| I (11) | 5.10 | 2.926 | 2.779 | 2.745 | 2.700 | 2.679 | 2.653 | 2.638 | 2.602 | 2.575 | 2.576 | 2.538 | 13.26 |
| I (12) | 4.10 | 2.914 | 2.774 | 2.769 | 2.720 | 2.689 | 2.677 | 2.632 | 2.628 | 2.562 | 2.558 | 2.474 | 15.10 |
| I (13) | 3.10 | 2.845 | 1.564 | 1.549 | 1.526 | 1.525 | 1.507 | 1.479 | 1.467 | 1.469 | 1.442 | 1.429 | 49.77 |
| I (14) | 2.00 | 2.815 | 0.603 | 0.471 | 0.355 | 0.271 | 0.233 | 0.192 | 0.156 | 0.160 | 0.126 | 0.104 | 96.31 |
| I (15) | 1.10 | 2.845 | 1.118 | — | — | — | — | — | — | — | — | — | — |
| I (16) | 0.00 | 2.912 | 2.217 | 2.047 | 1.874 | 1.721 | 1.562 | 1.398 | 1.209 | 1.093 | 1.032 | 0.823 | 71.74 |

Bleach Stability: 40° C.

Days of Stability

| | | 0 | 39 | 54 | 70 | 88 | 108 | 137 | 179 | 210 | 229 | 309 | |
|---|---|---|---|---|---|---|---|---|---|---|---|---|---|
| Sam- | % | % | % | % | % | % | % | % | % | % | % | % | Improvement |
| ple | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| I (9) | 8.10 | 2.941 | 2.644 | — | — | — | — | — | — | — | — | — | — |
| I (10) | 6.10 | 2.930 | 2.690 | 2.605 | 2.588 | 2.580 | 2.553 | 2.512 | 2.543 | 2.464 | 2.469 | 2.472 | 15.63 |
| I (11) | 5.10 | 2.926 | 2.715 | 2.617 | 2.589 | 2.568 | 2.565 | 2.536 | 2.468 | 2.441 | 2.440 | 2.207 | 24.57 |
| I (12) | 4.10 | 2.914 | 2.658 | 2.652 | 2.608 | 2.608 | 2.587 | 2.546 | 2.535 | 2.501 | 2.510 | 2.501 | 14.17 |
| I (13) | 3.10 | 2.845 | 1.467 | 1.441 | 1.415 | 1.398 | 1.382 | 1.360 | 1.337 | 1.339 | 1.312 | 1.300 | 54.31 |
| I (14) | 2.00 | 2.815 | 0.141 | 0.119 | 0.114 | 0.116 | 0.119 | 0.115 | 0.096 | 0.088 | 0.076 | 0.067 | 97.62 |
| I (15) | 1.10 | 2.845 | 0.475 | — | — | — | — | — | — | — | — | — | 71.74 |
| I (16) | 0.00 | 2.912 | 0.797 | 0.595 | 0.441 | 0.295 | 0.200 | 0.139 | 0.046 | 0.015 | 0.000 | 0.000 | 100 |

TABLE 6
Highly Alkaline Stabilized Bleaching Composition I with 3% Available Chlorine and Adjusted Alkalinity

| Ingredients | I (17) | I (18) | I (19) | I (20) | I (21) | I (22) | I (23) | I (24) |
|---|---|---|---|---|---|---|---|---|
| Deionized Water | 26.10 | 28.60 | 29.40 | 32.00 | 352.00 | 34.20 | 36.50 | 39.70 |
| Sodium Polyacrylate (50%), Good Rite | 0.80 | 0.80 | 0.80 | 0.80 | 0.80 | 0.80 | 0.80 | 0.80 |
| 7058 | | | | | | | | |
| 2-Phosphononobutane-1,2,4- | 1.20 | 1.20 | 1.20 | 1.20 | 1.20 | 1.20 | 1.20 | 1.20 |
| Tricarboxylic Acid (50%) | | | | | | | | |
| NaOH (50%) | 38.80 | 38.30 | 38.50 | 36.90 | 37.90 | 36.80 | 35.40 | 33.30 |
| Sulfamic Acid | 8.10 | 6.10 | 5.10 | 4.10 | 3.10 | 2.00 | 1.10 | 0.00 |
| NaOCl (Av. Cl. 12.00%) | 25.00 | 25.00 | 25.00 | 25.00 | 25.00 | 25.00 | 25.00 | 25.00 |
| Mole Ratio: NH₂SO₃H/NaOCl | 1.00/1.00 | 0.75/1.00 | 0.63/1.00 | 0.50/1.00 | 0.38/1.00 | 0.25/1.00 | 0.13/1.00 | 0.00/1.00 |
| pH (Neat, 19.5° C.) | 13.60 | 13.70 | 13.91 | 13.89 | 13.90 | 13.89 | 13.85 | 13.88 |
| pH, use solution (0.5% v/v, 22° C.) | — | 12.28 | — | 12.29 | — | — | — | 12.27 |
| Brookfield Viscosity, use solution (UL | — | 3.66 | — | 3.40 | — | — | — | 2.60 |
| Adapter, 25° C., 30 rpm), cps | | | | | | | | |

TABLE 7
Bleach Stability Data at Different Temperature Conditions-Highly Alkaline Stabilized Bleaching Composition I with 3% Available Chlorine
and Adjusted Alkalinity
Bleach Stability: 25° C.

Days of Stability

| | | 0 | 31 | 42 | 58 | 76 | 97 | 125 | 166 | 198 | 218 | 299 | |
|---|---|---|---|---|---|---|---|---|---|---|---|---|---|
| | | % | % | % | % | % | % | % | % | % | % | % | Improvement |
| Sample | % NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| I (17) | 8.10 | 2.930 | 2.776 | — | — | — | — | — | — | — | — | — | — |
| I (18) | 6.10 | 2.925 | 2.766 | 2.754 | 2.724 | 2.699 | 2.661 | 2.626 | 2.598 | 2.575 | 2.568 | 2.527 | 13.60 |
| I (19) | 5.10 | 2.943 | 2.787 | 2.767 | 2.700 | 2.640 | 2.603 | 2.573 | 2.559 | 2.540 | 2.514 | 2.470 | 16.07 |
| I (20) | 4.10 | 2.962 | 2.789 | 2.776 | 2.720 | 2.727 | 2.672 | 2.642 | 2.612 | 2.591 | 2.591 | 2.313 | 21.91 |
| I (21) | 3.10 | 2.834 | 1.590 | 1.571 | 1.526 | 1.521 | 1.516 | 1.511 | 1.500 | 1.464 | 1.437 | 1.442 | 49.11 |
| I (22) | 2.00 | 2.836 | 0.618 | 0.512 | 0.355 | 0.298 | 0.288 | 0.252 | 0.246 | 0.243 | 0.241 | 0.244 | 91.39 |
| I (23) | 1.10 | 2.891 | 1.160 | — | — | — | — | — | — | — | — | — | — |
| I (24) | 0.00 | 2.887 | 2.308 | 2.183 | 1.874 | 1.837 | 1.658 | 1.475 | 1.248 | 1.106 | 1.037 | 0.809 | 71.97 |

Bleach Stability: 40° C.

Days of Stability

| | | 0 | 38 | 47 | 58 | 76 | 97 | 125 | 166 | 198 | 218 | 299 | |
|---|---|---|---|---|---|---|---|---|---|---|---|---|---|
| | | % | % | % | % | % | % | % | % | % | % | % | Improvement |
| Sample | % NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| I (17) | 8.10 | 2.930 | — | — | — | — | — | — | — | — | — | — | — |
| I (18) | 6.10 | 2.925 | 2.439 | 2.405 | 2.402 | 2.346 | 2.306 | 2.249 | 2.202 | 2.146 | 2.139 | 2.095 | 28.37 |
| I (19 | 5.10 | 2.943 | 2.422 | 2.371 | 2.416 | 2.371 | 2.310 | 2.268 | 2.203 | 2.153 | 2.128 | 2.126 | 27.76 |
| I (20) | 4.10 | 2.962 | 2.497 | 2.470 | 2.608 | 2.418 | 2.384 | 2.326 | 2.272 | 2.233 | 2.215 | 2.123 | 28.32 |
| I (21) | 3.10 | 2.834 | 1.344 | 1.300 | 1.415 | 1.253 | 1.247 | 1.213 | 1.205 | 1.173 | 1.160 | 1.154 | 59.28 |
| I (22) | 2.00 | 2.836 | 0.151 | 0.186 | 0.114 | 0.199 | 0.204 | 0.190 | 0.168 | 0.162 | 0.138 | 0.141 | 95.03 |
| I (23) | 1.10 | 2.891 | — | — | — | — | — | — | — | — | — | — | — |
| I (24) | 0.00 | 2.887 | 0.697 | 0.608 | 0.441 | 0.330 | 0.215 | 0.079 | 0.013 | 0.013 | 0 | 0 | 100 |

TABLE 8
Highly Alkaline Stabilized Bleaching Composition I with 3.5% Available Chlorine and Adjusted Alkalinity

| Ingredients | I (25) | I (26) | I (27) | I (28) | I (29) | I (30) | I (31) | I (32) | I (33) |
|---|---|---|---|---|---|---|---|---|---|
| Deionized Water | 27.00 | 27.30 | 27.80 | 28.20 | 28.60 | 29.10 | 29.50 | 31.20 | 35.50 |
| Sodium Polyacrylate (50%), Good | 0.80 | 0.80 | 0.80 | 0.80 | 0.80 | 0.80 | 0.80 | 0.80 | 0.80 |
| Rite 7058 | | | | | | | | | |
| 2-Phosphononobutane-1,2,4- | 1.20 | 1.20 | 1.20 | 1.20 | 1.20 | 1.20 | 1.20 | 1.20 | 1.20 |
| Tricarboxylic Acid (50%) | | | | | | | | | |
| NaOH (50%) | 37.10 | 37.0 | 36.80 | 36.60 | 36.40 | 36.20 | 36.00 | 35.20 | 33.30 |
| Sulfamic Acid | 4.70 | 4.50 | 4.20 | 4.00 | 3.80 | 3.50 | 3.30 | 2.40 | 0.00 |
| NaOCl (Av. Cl. 12.00%) | 29.20 | 29.20 | 29.20 | 29.20 | 29.20 | 29.20 | 29.20 | 29.20 | 29.20 |
| Mole Ratio: NH₂SO₃H/NaOCl | 0.51/1.00 | 0.49/1.00 | 0.46/1.00 | 0.43/1.00 | 0.41/1.00 | 0.39/1.00 | 0.36/1.00 | 0.26/1.00 | 0.00/1.00 |
| pH (Neat, 19.5° C.) | 14.04 | 14.04 | 14.02 | 14.02 | 14.02 | 14.02 | 14.01 | 14.01 | 14.03 |
| pH, use solution (0.5% v/v, 22° C.) | 12.34 | — | — | 12.29 | — | — | 12.26 | — | 12.23 |
| Brookfield Viscosity, use solution | 6.24 | — | — | 5.90 | — | — | 5.56 | — | 4.52 |
| (UL Adapter, 25° C., 30 rpm), cps | | | | | | | | | |

TABLE 9
Bleach Stability Data at Different Temperature Conditions-Highly Alkaline Stabilized Bleaching Composition I
with 3.5% Available Chlorine and Adjusted Alkalinity
Bleach Stability: 25° C.

| | | Days of Stability | | | | | | | | |
|---|---|---|---|---|---|---|---|---|---|---|
| | | 0 | 12 | 32 | 61 | 105 | 138 | 156 | 206 | |
| | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | % Cl Lost |
| I (25) | 4.70 | 3.374 | 3.300 | 3.246 | 3.187 | 3.152 | 3.056 | 3.128 | 3.096 | 8.24 |
| I (26) | 4.47 | 3.423 | 3.075 | 3.023 | 2.990 | 2.910 | 2.880 | 2.850 | 2.844 | 16.91 |
| I (27) | 4.23 | 3.333 | 2.716 | 2.675 | 2.600 | 2.555 | 2.541 | 2.538 | 2.492 | 25.23 |
| I (28) | 4.00 | 3.320 | 2.347 | 2.293 | 2.254 | 2.232 | 2.188 | 2.162 | 2.094 | 36.93 |
| I (29) | 3.76 | 3.327 | 1.996 | 1.966 | 1.999 | 1.902 | 1.863 | 1.855 | 1.824 | 45.18 |
| I (30) | 3.53 | 3.325 | 1.660 | 1.609 | 1.594 | 1.545 | 1.538 | 1.500 | 1.490 | 55.19 |
| I (31) | 3.29 | 3.325 | 1.328 | 1.251 | 1.232 | 1.209 | 1.178 | 1.174 | 1.154 | 65.29 |
| I (32) | 2.40 | 3.337 | 0.974 | 0.531 | 0.331 | 0.308 | 0.217 | 0.202 | 0.183 | 94.52 |
| I (33) | 0.00 | 3.410 | 2.901 | 2.534 | 2.109 | 1.703 | 1.489 | 1.378 | 1.062 | 68.86 |

Bleach Stability: 40° C.

| | | Days of Stability | | | | | | | | |
|---|---|---|---|---|---|---|---|---|---|---|
| | | 0 | 12 | 32 | 61 | 105 | 138 | 156 | 206 | |
| | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Loss, % |
| I (25) | 4.70 | 3.374 | 2.930 | 2.835 | 2.764 | 2.686 | 2.659 | 2.623 | 2.628 | 22.11 |
| I (26) | 4.47 | 3.423 | 2.661 | 2.573 | 2.457 | 2.348 | 2.334 | 2.299 | 2.224 | 35.03 |
| I (27) | 4.23 | 3.333 | 2.317 | 2.257 | 2.123 | 2.083 | 2.055 | 2.024 | 2.038 | 38.65 |
| I (28) | 4.00 | 3.320 | 2.228 | 2.200 | 2.170 | 2.142 | 2.109 | 2.118 | 2.087 | 37.14 |
| I (29) | 3.76 | 3.327 | 1.836 | 1.832 | 1.812 | 1.787 | 1.774 | 1.758 | 1.725 | 48.18 |
| I (30) | 3.53 | 3.325 | 1.558 | 1.533 | 1.512 | 1.496 | 1.492 | 1.497 | 1.471 | 55.76 |
| I (31) | 3.29 | 3.325 | 1.071 | 1.027 | 0.990 | 0.974 | 0.967 | 0.953 | 0.935 | 71.88 |
| I (32) | 2.40 | 3.337 | 0.171 | 0.176 | 0.169 | 0.019 | 0.166 | 0.162 | 0.117 | 96.49 |
| I (33) | 0.00 | 3.410 | 1.558 | 0.725 | 0.427 | 0.028 | 0.085 | 0.061 | 0.022 | 99.35 |

### Highly Alkaline Stabilized Detergent Composition II

In this example, highly alkaline stabilized detergent compositions (“Composition II”) with 4% and 3% available chlorine, including some with adjusted alkalinity were studied. Following each table summarizing the composition of each detergent, stability data for each detergent is shown at various storage temperatures: 25° C., 40° C., and 50° C. In the samples with adjusted alkalinity, additional sodium hydroxide was added to the compositions to neutralize the added sulfamic acid and to keep the alkalinity of the composition substantially the same in all of the compositions. The amount of additional sodium hydroxide need was based on potentiometric titration of the alkaline composition containing sulfamic acid and chlorine bleach.

TABLE 10
Highly Alkaline Stabilized Detergent Composition II with 4% Available Chlorine

| Ingredients | II (1) | II (2) | II (3) | II (4) | II (5) | II (6) | II (7) | II (8) |
|---|---|---|---|---|---|---|---|---|
| Deionized Water | 34.20 | 36.90 | 38.20 | 39.60 | 40.90 | 42.20 | 43.50 | 45.00 |
| Sodium Polyacrylate (50%), Good Rite | 0.80 | 0.80 | 0.80 | 0.80 | 0.80 | 0.80 | 0.80 | 0.80 |
| 7058 | | | | | | | | |
| 2-Phosphononobutane-1,2,4-Tricarboxylic | 1.20 | 1.20 | 1.20 | 1.20 | 1.20 | 1.20 | 1.20 | 1.20 |
| Acid (50%) | | | | | | | | |
| NaOH (50%) | 20.00 | 20.00 | 20.00 | 20.00 | 20.00 | 20.00 | 20.00 | 20.00 |
| Sulfamic Acid | 10.80 | 8.10 | 6.80 | 5.40 | 4.10 | 2.70 | 1.40 | 0.00 |
| NaOCl (Av. Cl. 12.6%) | 33.00 | 33.00 | 33.00 | 33.00 | 33.00 | 33.00 | 33.00 | 33.00 |
| Mole Ratio: NH₂SO₃H/NaOCl | 1.00/1.00 | 0.75/1.00 | 0.63/1.00 | 0.50/1.00 | 0.38/1.00 | 0.25/1.00 | 0.13/1.00 | 0.00/1.00 |
| pH (Neat, 22.5° C.) | 13.88 | 13.92 | 13.86 | 13.90 | 13.94 | 13.85 | 13.87 | 13.90 |

TABLE 11
Bleach Stability Data at Different Temperatures —Highly Alkaline Detergent Composition II with 4% Available Chlorine
Bleach Stability: 25° C.

| | | Days of Stability | | | | | | | | | | | |
|---|---|---|---|---|---|---|---|---|---|---|---|---|---|
| | | 0 | 32 | 59 | 102 | 122 | 145 | 199 | 224 | 267 | 292 | 368 | |
| | % | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| II (1) | 10.8 | 3.954 | 3.785 | 3.733 | 3.684 | — | — | — | — | — | — | — | — |
| II (2) | 8.10 | 3.971 | 3.836 | 3.755 | 3.706 | 3.622 | 3.610 | 3.480 | 3.479 | 3.429 | 3.418 | 3.300 | 16.90 |
| II (3) | 6.80 | 3.963 | 3.801 | 3.739 | 3.698 | 3.576 | 3.568 | 3.426 | 3.454 | 3.410 | 3.375 | 3.240 | 18.20 |
| II (4) | 5.40 | 3.960 | 3.788 | 3.745 | 3.644 | 3.582 | 3.524 | 3.391 | 3.386 | 3.319 | 3.291 | 3.199 | 19.20 |
| II (5) | 4.10 | 3.758 | 1.355 | 1.309 | 1.287 | 1.254 | 1.230 | 1.187 | 1.175 | 1.168 | 1.137 | 1.111 | 70.40 |
| II (6) | 2.70 | 3.760 | 0.931 | 0.811 | 0.715 | 0.663 | 0.627 | 0.554 | 0.523 | 0.478 | 0.475 | 0.421 | 88.80 |
| II (7) | 1.40 | 3.833 | 2.154 | 2.007 | 1.824 | — | — | — | — | — | — | — | — |
| II (8) | 0.00 | 3.945 | 3.530 | 3.295 | 2.969 | 2.790 | 2.668 | 2.289 | 2.171 | 2.051 | 2.075 | 1.697 | 56.98 |

Bleach Stability: 40° C.

| | | Days of Stability | | | | | | | | | | | | |
|---|---|---|---|---|---|---|---|---|---|---|---|---|---|---|
| | | 0 | 32 | 61 | 102 | 123 | 139 | 159 | 199 | 227 | 263 | 292 | 368 | |
| | % | % | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | Av. Cl | % Cl Lost |
| II (1) | 10.8 | 3.954 | 3.778 | 3.723 | 3.677 | — | — | — | — | — | — | — | — | — |
| II (2) | 8.10 | 3.971 | 3.787 | 3.763 | 3.680 | 3.620 | 3.629 | 3.6050 | 3.585 | 3.585 | 3.591 | 3.566 | 3.561 | 10.30 |
| II (3) | 6.80 | 3.963 | 3.769 | 3.734 | 3.668 | 3.595 | 3.593 | 3.5760 | 3.5450 | 3.584 | 3.583 | 3.547 | 3.554 | 10.30 |
| II (4) | 5.40 | 3.960 | 3.517 | 3.417 | 3.392 | 3.299 | 3.262 | 3.2590 | 3.2450 | 3.212 | 3.124 | 3.102 | 3.196 | 19.30 |
| II (5) | 4.10 | 3.758 | 1.272 | 1.243 | 1.193 | 1.161 | 1.157 | 1.1420 | 1.109 | 1.085 | 1.075 | 1.076 | 1.079 | 71.30 |
| II (6) | 2.70 | 3.760 | 0.565 | 0.443 | 1.367 | 0.267 | 0.269 | 0.2440 | 0.18 | 0.145 | 0.102 | 0.070 | 0.028 | 99.30 |
| II (7) | 1.40 | 3.833 | 1.306 | 0.988 | 1.697 | — | — | — | — | — | — | — | — | — |
| II (8) | 0.00 | 3.945 | 1.837 | 1.184 | 0.803 | 0.616 | 0.549 | 0.4510 | 0.329 | 0.267 | 0.184 | 0.149 | 0.047 | 98.80 |

Bleach Stability: 50° C.

| | | Days of Stability | | | | | | | | | | |
|---|---|---|---|---|---|---|---|---|---|---|---|---|
| | | 0 | 32 | 61 | 87 | 102 | 124 | 145 | 199 | 227 | 263 | |
| | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | % Cl Loss |
| II (1) | 10.8 | 3.954 | 3.559 | 3.513 | 3.420 | 3.304 | — | — | — | — | — | — |
| II (2) | 8.10 | 3.971 | 3.639 | 3.403 | 3.341 | 3.209 | 3.064 | 2.981 | 2.664 | 2.672 | 2.395 | 39.70 |
| II (3) | 6.80 | 3.963 | 3.529 | 3.272 | 3.140 | 3.010 | 2.839 | 2.745 | 2.505 | 2.308 | 2.572 | 35.10 |
| II (4) | 5.40 | 3.960 | 3.133 | 2.870 | 2.767 | 2.629 | 2.482 | 2.342 | 2.232 | 2.066 | 1.994 | 49.60 |
| II (5) | 4.10 | 3.758 | 1.120 | 1.066 | 1.030 | 0.972 | 0.913 | 0.888 | 0.876 | 0.827 | 0.392 | 89.60 |
| II (6) | 2.70 | 3.760 | 0.303 | 0.135 | 0.061 | 0.014 | 0.007 | — | — | — | — | — |
| II (7) | 1.40 | 3.833 | 0.568 | 0.243 | 0.168 | 0.113 | — | — | — | — | — | — |
| II (8) | 0.00 | 3.945 | 0.786 | 0.330 | 0.228 | 0.139 | 0.078 | 0.032 | 0.013 | 0.006 | 0.014 | 99.60 |

TABLE 12
Highly Alkaline Stabilized Bleaching Composition II with 3% Available Chlorine

| Ingredients | II (9) | II (10) | II (11) | II (12) | II (13) | II (14) | II (15) | II (16) |
|---|---|---|---|---|---|---|---|---|
| Deionized Water | 44.90 | 46.90 | 47.90 | 48.90 | 49.90 | 51.00 | 51.90 | 53.00 |
| Sodium Polyacrylate (50%), Good | 0.80 | 0.80 | 0.80 | 0.80 | 0.80 | 0.80 | 0.80 | 0.80 |
| Rite 7058 | | | | | | | | |
| 2-Phosphononobutane-1,2,4- | 1.20 | 1.20 | 1.20 | 1.20 | 1.20 | 1.20 | 1.20 | 1.20 |
| Tricarboxylic Acid (50%) | | | | | | | | |
| NaOH (50%) | 20.00 | 20.00 | 20.00 | 20.00 | 20.00 | 20.00 | 20.00 | 20.00 |
| Sulfamic Acid | 8.10 | 6.10 | 5.10 | 4.10 | 3.10 | 2.00 | 1.10 | 0.00 |
| NaOCl (Av. Cl. 12.6%) | 25.00 | 25.00 | 25.00 | 25.00 | 25.00 | 25.00 | 25.00 | 25.00 |
| Mole Ratio: NH₂SO₃H/NaOCl | 1.00/1.00 | 0.75/1.00 | 0.63/1.00 | 0.50/1.00 | 0.38/1.00 | 0.25/1.00 | 0.13/1.00 | 0.00/1.00 |
| pH (Neat, 24.5° C.) | 12.89 | 12.95 | 12.93 | 12.93 | 12.93 | 12.90 | 12.90 | 12.93 |
| pH, use solution (0.5% v/v, 22° C.) | — | 11.94 | — | 11.94 | — | — | — | 12.00 |
| Brookfield Viscosity, use solution | — | 2.56 | — | 2.68 | — | — | — | 2.44 |
| (UL Adapter, 25° C., 30 rpm), cps | | | | | | | | |

TABLE 13
Bleach Stability Data at Different Temperatures-Highly Alkaline Stabilized Bleaching Composition II with 3% Available Chlorine

| | | Days of Stability | | | | | | | | | | | |
|---|---|---|---|---|---|---|---|---|---|---|---|---|---|
| | | 0 | 35 | 50 | 67 | 85 | 105 | 134 | 176 | 210 | 227 | 297 | Improve- |
| | % | % | % | % | % | % | % | % | % | % | % | % | ment |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |

Bleach Stability: 25° C.

| | | | | | | | | | | | | | |
|---|---|---|---|---|---|---|---|---|---|---|---|---|---|
| II (9) | 8.10 | 2.964 | 2.759 | — | — | — | — | — | — | — | — | — | — |
| II (10) | 6.10 | 2.904 | 2.753 | 2.729 | 2.693 | 2.659 | 2.637 | 2.620 | 2.578 | 2.519 | 2.500 | 2.486 | 14.39 |
| II (11) | 5.10 | 2.924 | 2.791 | 2.771 | 2.726 | 2.710 | 2.681 | 2.671 | 2.645 | 2.653 | 2.598 | 2.574 | 11.97 |
| II (12) | 4.10 | 2.923 | 2.764 | 2.748 | 2.728 | 2.679 | 2.620 | 2.599 | 2.542 | 2.531 | 2.516 | 2.501 | 14.44 |
| II (13) | 3.10 | 2.802 | 1.351 | 1.331 | 1.292 | 1.267 | 1.269 | 1.242 | 1.208 | 1.209 | 1.209 | 1.151 | 58.92 |
| II (14) | 2.00 | 2.815 | 0.682 | 0.621 | 0.562 | 0.528 | 0.499 | 0.473 | 0.419 | 0.389 | 0.360 | 0.314 | 88.85 |
| II (15) | 1.10 | 2.878 | 1.486 | — | — | — | — | — | — | — | — | — | — |
| II (16) | 0.00 | 2.907 | 2.557 | 2.458 | 2.339 | 2.187 | 2.081 | 1.964 | 1.816 | 1.698 | 1.640 | 1.462 | 49.71 |

Bleach Stability: 40° C.

| | | | | | | | | | | | | | |
|---|---|---|---|---|---|---|---|---|---|---|---|---|---|
| II (9) | 8.10 | 2.964 | 2.784 | — | — | — | — | — | — | — | — | — | — |
| II (10) | 6.10 | 2.904 | 2.741 | 2.723 | 2.684 | 2.686 | 2.662 | 2.624 | 2.596 | 2.580 | 2.535 | 2.586 | 10.95 |
| II (11) | 5.10 | 2.924 | 2.780 | 2.753 | 2.721 | 2.691 | 2.685 | 2.639 | 2.630 | 2.577 | 2.618 | 2.543 | 13.03 |
| II (12) | 4.10 | 2.923 | 2.766 | 2.702 | 2.671 | 2.647 | 2.631 | 2.579 | 2.572 | 2.545 | 2.507 | 2.493 | 14.71 |
| II (13) | 3.10 | 2.802 | 1.279 | 1.252 | 1.227 | 1.208 | 1.210 | 1.187 | 1.059 | 1.141 | 1.134 | 1.086 | 61.24 |
| II (14) | 2.00 | 2.815 | 0.416 | 0.362 | 0.316 | 0.279 | 0.256 | 0.213 | 0.169 | 0.135 | 0.087 | 0.062 | 97.80 |
| II (15) | 1.10 | 2.878 | 1.005 | — | — | — | — | — | — | — | — | — | — |
| II (16) | 0.00 | 2.907 | 1.524 | 1.281 | 1.094 | 0.923 | 0.767 | 0.598 | 0.469 | 0.361 | 0.319 | 0.215 | 92.60 |

TABLE 14
Highly Alkaline Stabilized Bleaching Composition II with 3% Available Chlorine and Adjusted Alkalinity

| Ingredients | II (17) | II (18) | II (19) | II (20) | II (21) | II (22) | II (23) | II (24) |
|---|---|---|---|---|---|---|---|---|
| Deionized Water | 35.60 | 39.60 | 43.90 | 43.50 | 44.80 | 46.20 | 47.30 | 53.00 |
| Sodium Polyacrylate (50%), Good Rite | 0.80 | 0.80 | 0.80 | 0.80 | 0.80 | 0.80 | 0.80 | 0.80 |
| 7058 | | | | | | | | |
| 2-Phosphononobutane-1,2,4- | 1.20 | 1.20 | 1.20 | 1.20 | 1.20 | 1.20 | 1.20 | 1.20 |
| Tricarboxylic Acid (50%), Bayhabit | | | | | | | | |
| AM | | | | | | | | |
| NaOH (50%) | 29.30 | 27.30 | 24.00 | 25.40 | 25.10 | 24.80 | 24.60 | 20.00 |
| Sulfamic Acid | 8.10 | 6.10 | 5.10 | 4.10 | 3.10 | 2.00 | 1.10 | 0.00 |
| NaOCl (Av. Cl. 12.6%) | 25.00 | 25.00 | 25.00 | 25.00 | 25.00 | 25.00 | 25.00 | 25.00 |
| Mole Ratio: NH₂SO₃H/NaOCl | 1.00/1.00 | 0.75/1.00 | 0.63/1.00 | 0.50/1.00 | 0.38/1.00 | 0.25/1.00 | 0.13/1.00 | 0.00/1.00 |
| pH (Neat, 19.5° C.) | 13.40 | 13.47 | 13.53 | 13.57 | 13.61 | 13.61 | 13.60 | 13.61 |
| pH, use solution (0.5% v/v, 22° C.) | — | 12.13 | — | 12.10 | — | — | — | 12.04 |
| Brookfield Viscosity, use solution | — | 5.60 | — | 6.28 | — | — | — | 4.58 |
| (25° C., 30 rpm), cps (UL Adapter) | | | | | | | | |

TABLE 15
Bleach Stability Data at Different Temperature-Highly Alkaline Stabilized Bleaching Composition II with 3% Available Chlorine and
Adjusted Alkalinity
Bleach Stability: 25° C.

| | | Days of Stability | | | | | | | | | | | |
|---|---|---|---|---|---|---|---|---|---|---|---|---|---|
| | | 0 | 10 | 31 | 41 | 55 | 73 | 94 | 165 | 197 | 218 | 299 | Improve- |
| | % | % | % | % | % | % | % | % | % | % | % | % | ment |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| II (17) | 8.10 | 2.926 | 2.830 | 2.796 | — | — | — | — | — | — | — | — | — |
| II (18) | 6.10 | 2.953 | 2.822 | 2.807 | 2.786 | 2.693 | 2.689 | 2.682 | 2.666 | 2.629 | 2.618 | 2.578 | 12.70 |
| II (19) | 5.10 | 2.918 | 2.856 | 2.783 | 2.768 | 2.726 | 2.709 | 2.694 | 2.630 | 2.613 | 2.589 | 2.581 | 11.55 |
| II (20) | 4.10 | 2.941 | 2.822 | 2.792 | 2.791 | 2.728 | 2.713 | 2.695 | 2.639 | 2.600 | 2.609 | 2.519 | 14.35 |
| II (21) | 3.10 | 2.828 | 1.370 | 1.323 | 1.276 | 1.276 | 1.264 | 1.244 | 1.220 | 1.187 | 1.178 | 1.172 | 58.56 |
| II (22) | 2.00 | 2.808 | 1.039 | 0.696 | 0.596 | 0.562 | 0.423 | 0.38 | 0.242 | 0.209 | 0.175 | 0.103 | 96.33 |
| II (23) | 1.10 | 2.832 | 1.768 | 1.479 | — | — | — | — | — | — | — | — | — |
| II (24) | 0.00 | 2.893 | 2.767 | 2.616 | 2.516 | 2.339 | 2.322 | 2.360 | 1.808 | 1.708 | 1.642 | 1.437 | 50.31 |

Bleach Stability: 40° C.

| | | Days of Stability | | | | | | | | | | | |
|---|---|---|---|---|---|---|---|---|---|---|---|---|---|
| | | 0 | 10 | 38 | 45 | 55 | 73 | 94 | 165 | 197 | 218 | 299 | Improve- |
| | % | % | % | % | % | % | % | % | % | % | % | % | ment |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| II (17) | 8.10 | 2.926 | 2.816 | — | — | — | — | — | — | — | — | — | — |
| II (18) | 6.10 | 2.953 | 2.842 | 2.787 | 2.771 | 2.684 | 2.672 | 2.682 | 2.669 | 2.673 | 2.655 | 2.629 | 11.00 |
| II (19) | 5.10 | 2.918 | 2.848 | 2.800 | 2.766 | 2.721 | 2.714 | 2.709 | 2.665 | 2.689 | 2.678 | 2.640 | 9.60 |
| II (20) | 4.10 | 2.941 | 2.803 | 2.757 | 2.675 | 2.671 | 2.644 | 2.632 | 2.564 | 2.483 | 2.471 | 2.554 | 13.20 |
| II (21) | 3.10 | 2.828 | 1.276 | 1.236 | 1.202 | 1.216 | 1.194 | 1.182 | 1.133 | 1.135 | 1.125 | 1.127 | 60.10 |
| II (22) | 2.00 | 2.808 | 0.362 | 0.211 | 0.193 | 0.302 | 0.116 | 0.085 | 0.020 | 0.019 | 0.010 | 0.010 | 99.60 |
| II (23) | 1.10 | 2.832 | 1.194 | — | — | — | — | — | — | — | — | — | — |
| II (24) | 0.00 | 2.893 | 2.260 | 1.527 | 1.415 | 1.094 | 0.957 | 0.999 | 0.423 | 0.355 | 0.271 | 0.236 | 91.80 |

### Highly Alkaline Stabilized Detergent Composition III

In this example, highly alkaline stabilized detergent compositions (“Composition III”) with 3% chlorine and 3% chlorine with adjusted alkalinity were studied. Following the table summarizing the composition of each detergent, stability data for each detergent is shown at various storage temperatures: 25° C., 40° C., and 50° C. In the samples with adjusted alkalinity, additional sodium hydroxide was added to the compositions to neutralize the added sulfamic acid and to keep the alkalinity of the composition substantially the same in all of the compositions. The amount of additional sodium hydroxide need was based on potentiometric titration of the alkaline composition containing sulfamic acid and chlorine bleach.

TABLE 16
Highly Alkaline Stabilized Bleaching Composition III with 3% Available Chlorine and Adjusted Alkalinity

| Ingredients | III (1) | III (2) | III (3) | III (4) | III (5) | III (6) | III (7) | III (8) |
|---|---|---|---|---|---|---|---|---|
| Deionized Water | 26.10 | 31.64 | 33.84 | 36.14 | 38.44 | 40.94 | 42.94 | 45.54 |
| Sodium Glucoheptanoate | 0.06 | 0.06 | 0.06 | 0.06 | 0.06 | 0.06 | 0.06 | 0.06 |
| Sodium Tripolyphosphate | 5.00 | 5.00 | 5.00 | 5.00 | 5.00 | 5.00 | 5.00 | 5.00 |
| KOH (45%) | 34.90 | 32.20 | 31.00 | 29.70 | 28.40 | 27.00 | 25.90 | 24.40 |
| Sulfamic Acid | 8.10 | 6.10 | 5.10 | 4.10 | 3.10 | 2.00 | 1.10 | 0.00 |
| NaOCl (Av. 12.00%) | 25.00 | 25.00 | 25.00 | 25.00 | 25.00 | 25.00 | 25.00 | 25.00 |
| Mole Ratio: NH₂SO₃H/NaOCl | 1.00/1.00 | 0.75/1.00 | 0.63/1.00 | 0.50/1.00 | 0.38/1.00 | 0.25/1.00 | 0.13/1.00 | 0.00/1.00 |
| pH (Neat, 21.2° C.) | 14.26 | 14.23 | 14.23 | 14.21 | 14.17 | 14.16 | 14.14 | 14.11 |
| pH, use solution (0.5% v/v, | — | 11.94 | — | 11.96 | — | — | — | 11.93 |
| 22° C.) | | | | | | | | |
| Brookfield Viscosity, use | — | 2.52 | — | 2.28 | — | — | — | 2.14 |
| solution (UL Adapter, 25° C., 30 rpm), | | | | | | | | |
| cps | | | | | | | | |

TABLE 17
Bleach Stability Data at Different Temperatures - Highly Alkaline Stabilized Bleaching Composition III with 3% Available
Chlorine and Adjusted Alkalinity
Bleach Stability: 25° C.

| | | Days of Stability | | | | | | | | | | |
|---|---|---|---|---|---|---|---|---|---|---|---|---|
| | | 0 | 8 | 15 | 28 | 49 | 68 | 98 | 138 | 191 | 270 | |
| | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | % Cl Lost |
| III (1) | 8.10 | 2.973 | 2.819 | 2.805 | — | — | — | — | — | — | — | — |
| III (2) | 6.10 | 3.018 | 2.853 | 2.827 | 2.817 | 2.744 | 2.738 | 2.723 | 2.711 | 2.684 | 2.659 | 11.90 |
| III (3) | 5.10 | 3.007 | 2.894 | 2.826 | 2.816 | 2.789 | 2.760 | 2.746 | 2.710 | 2.683 | 2.635 | 12.37 |
| III (4) | 4.10 | 2.974 | 2.824 | 2.815 | 2.783 | 2.722 | 2.696 | 2.652 | 2.624 | 2.566 | 2.515 | 15.43 |
| III (5) | 3.10 | 2.720 | 1.310 | 1.300 | 0.915 | 1.032 | 1.236 | 1.219 | 1.194 | 1.146 | 1.176 | 56.76 |
| III (6) | 2.00 | 2.734 | 0.832 | 0.729 | 0.651 | 0.614 | 0.560 | 0.546 | 0.500 | 0.491 | 0.458 | 83.25 |
| III (7) | 1.10 | 2.799 | 1.650 | 1.567 | — | — | — | — | — | — | — | — |
| III (8) | 0.00 | 3.023 | 2.820 | 2.754 | 2.609 | 2.461 | 2.339 | 2.176 | 1.974 | 1.720 | 1.499 | 50.41 |

Bleach Stability: 40° C.

| | | Days of Stability | | | | | | | | | | |
|---|---|---|---|---|---|---|---|---|---|---|---|---|
| | | 0 | 9 | 19 | 30 | 49 | 68 | 98 | 138 | 190 | 270 | |
| | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | % Cl Lost |
| III (1) | 8.10 | 2.973 | 2.897 | 2.857 | — | — | — | — | — | — | — | — |
| III (2) | 6.10 | 3.018 | 2.984 | 2.857 | 2.803 | 2.781 | 2.784 | 2.724 | 2.723 | 2.696 | 2.750 | 8.88 |
| III (3) | 5.10 | 3.007 | 2.926 | 2.853 | 2.798 | 2.798 | 2.769 | 2.750 | 2.709 | 2.662 | 2.693 | 10.44 |
| III (4) | 4.10 | 2.974 | 2.839 | 2.796 | 2.514 | 2.663 | 2.650 | 2.568 | 2.529 | 2.400 | 2.274 | 23.54 |
| III (5) | 3.10 | 2.720 | 1.318 | 1.257 | 1.205 | 1.197 | 1.159 | 1.147 | 1.113 | 1.082 | 1.027 | 62.24 |
| III (6) | 2.00 | 2.734 | 0.626 | 0.566 | 0.496 | 0.434 | 0.385 | 0.329 | 0.261 | 0.201 | 0.129 | 95.28 |
| III (7) | 1.10 | 2.799 | 1.493 | 1.245 | — | — | — | — | — | — | — | — |
| III (8) | 0.00 | 3.023 | 2.363 | 1.930 | 1.564 | 1.237 | 0.980 | 0.74 | 0.558 | 0.411 | 0.279 | 90.77 |

### Highly Alkaline Stabilized Detergent Composition IV

In this example, highly alkaline stabilized detergent compositions (“Composition IV”) with 2% chlorine were studied. Following the table summarizing the composition of each detergent, stability data for each detergent is shown at various storage temperatures: 25° C., 40° C., and 50° C.

TABLE 18
Highly Alkaline Stabilized Bleaching Composition IV with 2% Available Chlorine

| Ingredients | IV (1) | IV (2) | IV (3) | IV (4) | IV (5) | IV (6) | IV (7) | IV (8) |
|---|---|---|---|---|---|---|---|---|
| Deionized Water | 31.10 | 32.40 | 33.10 | 33.80 | 34.40 | 35.10 | 35.80 | 36.50 |
| Sodium | 9.50 | 9.50 | 9.50 | 9.50 | 9.50 | 9.50 | 9.50 | 9.50 |
| Tripolyphosphate | | | | | | | | |
| KOH (45%) | 28.00 | 28.00 | 28.00 | 28.00 | 28.00 | 28.00 | 28.00 | 28.00 |
| Potassium Silicate (29%) | 9.50 | 9.50 | 9.50 | 9.50 | 9.50 | 9.50 | 9.50 | 9.50 |
| Sulfamic Acid | 5.40 | 4.10 | 3.40 | 2.70 | 2.10 | 1.40 | 0.70 | 0.00 |
| NaOCl (Av. 12.6%) | 16.50 | 16.50 | 16.50 | 16.50 | 16.50 | 16.50 | 16.50 | 16.50 |
| Mole Ratio: | 1.00/1.00 | 0.75/1.00 | 0.63/1.00 | 0.50/1.00 | 0.38/1.00 | 0.25/1.00 | 0.13/1.00 | 0.00/1.00 |
| NH₂SO₃H/NaOCl | | | | | | | | |
| pH (Neat, 19.5° C.) | 13.97 | 14.02 | 14.08 | 14.1 | 14.1 | 14.1 | 14.1 | 14.12 |

TABLE 19
Bleach Stability Data at Different Temperature Conditions-Highly Alkaline Stabilized Bleaching Composition IV with 2% Available
Chlorine
Bleach Stability: 25° C.

| | | Days of Stability | | | | | | | | | | | | |
|---|---|---|---|---|---|---|---|---|---|---|---|---|---|---|
| | | 0 | 33 | 67 | 95 | 123 | 145 | 167 | 195 | 224 | 259 | 289 | 368 | |
| | % | % | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | Av. Cl | % Cl Lost |
| IV (1) | 5.40 | 2.000 | 1.960 | 1.916 | 1.873 | — | — | — | — | — | — | — | — | — |
| IV (2) | 4.10 | 2.037 | 1.976 | 1.943 | 1.877 | 1.822 | 1.807 | 1.796 | 1.755 | 1.706 | 1.693 | 1.685 | 1.645 | 19.24 |
| IV (3) | 3.40 | 2.039 | 1.973 | 1.942 | 1.880 | 1.816 | 1.784 | 1.764 | 1.751 | 1.728 | 1.686 | 1.665 | 1.660 | 18.54 |
| IV (4) | 2.70 | 2.021 | 1.809 | 1.767 | 1.701 | 1.647 | 1.595 | 1.592 | 1.588 | 1.550 | 1.522 | 1.497 | 1.421 | 29.69 |
| IV (5) | 2.10 | 1.973 | 0.584 | 0.582 | 0.553 | 0.538 | 0.523 | 0.514 | 0.512 | 0.495 | 0.478 | 0.449 | 0.436 | 77.90 |
| IV (6) | 1.40 | 1.986 | 0.461 | 0.367 | 0.329 | 0.289 | 0.270 | 0.245 | 0.229 | 0.211 | 0.198 | 1.840 | 0.145 | 92.70 |
| IV (7) | 0.70 | 2.020 | 1.132 | 1.018 | 0.926 | — | — | — | — | — | — | — | — | — |
| IV (8) | 0.00 | 2.077 | 1.844 | 1.681 | 1.519 | 1.397 | 1.308 | 1.242 | 1.149 | 1.060 | 0.961 | 1.104 | 0.732 | 64.76 |

Bleach Stability: 40° C.

| | | Days of Stability | | | | | | | | | | | | |
|---|---|---|---|---|---|---|---|---|---|---|---|---|---|---|
| | | 0 | 33 | 67 | 95 | 125 | 140 | 167 | 195 | 224 | 260 | 289 | 368 | |
| | % | % | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | Av. Cl | % Cl Lost |
| IV (1) | 5.40 | 2.000 | 1.982 | 1.922 | 1.894 | — | — | — | — | — | — | — | — | — |
| IV (2) | 4.10 | 2.037 | 1.958 | 1.933 | 1.929 | 1.907 | 1.907 | 1.863 | 1.852 | 1.851 | 1.858 | 1.848 | 1.838 | 9.77 |
| IV (3) | 3.40 | 2.039 | 1.948 | 1.931 | 1.919 | 1.881 | 1.850 | 1.782 | 1.837 | 1.795 | 1.761 | 1.747 | 1.704 | 16.43 |
| IV (4) | 2.70 | 2.021 | 1.705 | 1.643 | 1.567 | 1.540 | 1.498 | 1.161 | 1.421 | 1.363 | 1.346 | 1.327 | 1.298 | 35.77 |
| IV (5) | 2.10 | 1.973 | 0.557 | 0.545 | 0.526 | 0.507 | 0.506 | 0.486 | 0.484 | 0.480 | 0.470 | 0.480 | 0.495 | 74.91 |
| IV (6) | 1.40 | 1.986 | 0.256 | 0.208 | 0.169 | 0.126 | 0.124 | 0.118 | 0.105 | 0.087 | 0.076 | 0.066 | 0.051 | 97.48 |
| IV (7) | 0.70 | 2.020 | 0.696 | 0.485 | 0.346 | — | — | — | — | — | — | — | — | — |
| IV (8) | 0.00 | 2.077 | 0.937 | 0.596 | 0.421 | 0.330 | 0.309 | 0.235 | 0.204 | 0.155 | 0.135 | 0.051 | 0.055 | 97.35 |

Bleach Stability: 50° C.

| | | Days of Stability | | | | | | | | | | |
|---|---|---|---|---|---|---|---|---|---|---|---|---|
| | | 0 | 34 | 67 | 96 | 125 | 145 | 170 | 196 | 224 | 260 | |
| | % | % | % | % | % | % | % | % | % | % | % | Improvement |
| Sample | NH₂SO₃H | Av. Cl | Av. Cl | Av. Cl | Av. Cl | Av. Cl | Av. Cl | Av. Cl | Av. Cl | Av. Cl | Av. Cl | % Cl Lost |
| IV (1) | 5.40 | 2.000 | 1.948 | 1.825 | 1.695 | — | — | — | — | — | — | — |
| IV (2) | 4.10 | 2.037 | 1.930 | 1.758 | 1.591 | 1.468 | 1.387 | 1.307 | 1.260 | 1.187 | 1.091 | 46.49 |
| IV (3) | 3.40 | 2.039 | 1.868 | 1.750 | 1.610 | 1.459 | 1.390 | 1.307 | 1.235 | 1.123 | 1.015 | 50.22 |
| IV (4) | 2.70 | 2.021 | 1.476 | 1.220 | 1.081 | 0.989 | 0.911 | 0.859 | 0.832 | 0.789 | 0.729 | 63.93 |
| IV (5) | 2.10 | 1.973 | 0.521 | 0.464 | 0.415 | 0.375 | 0.370 | 0.342 | 0.345 | 0.345 | 0.330 | 83.27 |
| IV (6) | 1.40 | 1.986 | 0.145 | 0.087 | 0.047 | — | — | — | — | — | — | — |
| IV (7) | 0.70 | 2.020 | 0.287 | 0.124 | 0.057 | — | — | — | — | — | — | — |
| IV (8) | 0.00 | 2.077 | 0.318 | 0.114 | 0.066 | 0.034 | 0.017 | 0.006 | — | — | — | 100.00 |

### Highly Alkaline Stabilized Detergent Composition V

In this example, highly alkaline stabilized detergent compositions (“Composition V”) with 3.5% chlorine were studied. Following the table summarizing the composition of each detergent, stability data for each detergent is shown at various storage temperatures: 25° C. and 40° C.

TABLE 20
Highly Alkaline Stabilized Bleaching Composition V with 3.5% Available Chlorine

| Ingredients | V (1) | V (2) | V (3) | V (4) | V (5) | V (6) | V (7) | V (8) |
|---|---|---|---|---|---|---|---|---|
| Deionized Water | 32.30 | 34.70 | 35.80 | 37.10 | 38.20 | 39.40 | 40.60 | 41.80 |
| Sodium Polyacrylate (50%), Good Rite 7058 | 0.80 | 0.80 | 0.80 | 0.80 | 0.80 | 0.80 | 0.80 | 0.80 |
| 2-Phosphonobutane-1,2,4-Tricarboxylic Acid (50%), | 1.20 | 1.20 | 1.20 | 1.20 | 1.20 | 1.20 | 1.20 | 1.20 |
| Bayhabit AM | | | | | | | | |
| NaOH (50%) | 27.00 | 27.00 | 27.00 | 27.00 | 27.00 | 27.00 | 27.00 | 27.00 |
| Sulfamic Acid | 9.50 | 7.10 | 6.00 | 4.70 | 3.60 | 2.40 | 1.20 | 0.00 |
| NaOCl (av. Cl. 12.00%) | 29.20 | 29.20 | 29.20 | 29.20 | 29.20 | 29.20 | 29.20 | 29.20 |
| Mole Ratio: NH₂SO₃H/NaOCl | 1.00/1.0 | 0.78/1.0 | .066/1.0 | 0.51/1.0 | 0.37/1.0 | 0.26/1.0 | 0.13/1.0 | 0.00/1.0 |
| pH (Neat, 19.5° C.) | 13.9 | 13.97 | 13.94 | 13.87 | 13.79 | 13.67 | 13.71 | 13.71 |
| pH, use solution (0.5% v/v, 22° C.) | — | 12.17 | — | 12.19 | — | — | — | 12.16 |
| Brookfield Viscosity, use solution (UL Adapter, | — | 4.92 | — | 4.64 | — | — | — | 3.40 |
| 25° C., 30 rpm), cps | | | | | | | | |

TABLE 21
Bleach Stability Data at Different Temperature Conditions-Highly-Alkaline Stabilized Bleaching Composition V with 3.5% Available
Chlorine
Bleach Stability: 25° C.

| | | Days of Stability | | | | | | | | | | | |
|---|---|---|---|---|---|---|---|---|---|---|---|---|---|
| | | 0 | 28 | 42 | 54 | 72 | 96 | 125 | 166 | 192 | 219 | 299 | Improve- |
| | % | % | % | % | % | % | % | % | % | % | % | % | ment |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| V (1) | 9.50 | 3.472 | 3.237 | — | — | — | — | — | — | — | — | — | — |
| V (2) | 7.10 | 3.486 | 3.296 | 3.263 | 3.226 | 3.142 | 3.135 | 3.077 | 3.067 | 3.011 | 2.991 | 2.905 | 16.67 |
| V (3) | 6.00 | 3.458 | 3.293 | 3.257 | 3.245 | 3.204 | 3.184 | 3.149 | 3.071 | 3.080 | 3.066 | 3.031 | 12.35 |
| V (4) | 4.70 | 3.452 | 3.227 | 3.216 | 3.144 | 3.008 | 3.162 | 3.135 | 3.024 | 3.070 | 3.052 | 3.007 | 12.89 |
| V (5) | 3.60 | 3.354 | 1.542 | 1.514 | 1.491 | 1.491 | 1.462 | 1.447 | 1.417 | 1.414 | 1.400 | 1.376 | 58.97 |
| V (6) | 2.40 | 3.350 | 0.786 | 0.638 | 0.525 | 0.425 | 0.365 | 0.291 | 0.207 | 0.161 | 0.116 | 0.074 | 97.79 |
| V (7) | 1.20 | 3.375 | 1.670 | — | — | — | — | — | — | — | — | — | — |
| V (8) | 0.00 | 3.430 | 2.888 | 2.710 | 2.575 | 2.383 | 2.145 | 1.933 | 1.748 | 1.543 | 1.463 | 1.222 | 64.37 |

Bleach Stability: Ambient/40° C.

| | | Days of Stability | | | | | | | | | | | |
|---|---|---|---|---|---|---|---|---|---|---|---|---|---|
| | | 0 | 28 | 42 | 54 | 72 | 96 | 125 | 166 | 192 | 218 | 299 | Improve- |
| | % | % | % | % | % | % | % | % | % | % | % | % | ment |
| Sample | NH₂SO₃H | Av. Cl | Av. Cl | Av. Cl | Av. Cl | Av. Cl | Av. Cl | Av. Cl | Av. Cl | Av. Cl | Av. Cl | Av. Cl | % Cl Lost |
| V (1) | 9.50 | 3.472 | 3.008 | — | — | — | — | — | — | — | — | — | — |
| V (2) | 7.10 | 3.486 | 3.158 | 3.055 | 3.042 | 2.997 | 3.031 | 3.024 | 2.970 | 2.959 | 2.949 | 2.861 | 17.93 |
| V (3) | 6.00 | 3.458 | 3.198 | 3.137 | 3.086 | 3.073 | 3.054 | 3.008 | 2.916 | 2.928 | 2.916 | 2.933 | 15.18 |
| V (4) | 4.70 | 3.452 | 3.205 | 3.135 | 3.063 | 3.043 | 3.019 | 2.950 | 2.895 | 2.824 | 2.783 | 2.826 | 18.13 |
| V (5) | 3.60 | 3.354 | 1.456 | 1.395 | 1.38 | 1.365 | 1.348 | 1.332 | 1.305 | 1.276 | 1.301 | 1.286 | 61.66 |
| V (6) | 2.40 | 3.350 | 0.179 | 0.103 | 0.044 | 0.021 | 0.023 | 0.014 | 0.004 | 0.007 | 0.022 | 0.010 | 99.70 |
| V (7) | 1.20 | 3.375 | 0.789 | — | — | — | — | — | — | — | — | — | — |
| V (8) | 0.00 | 3.430 | 1.265 | 0.997 | 0.789 | 0.676 | 0.508 | 0.337 | 0.184 | 0.118 | 0.060 | 0.000 | 100.00 |

In each of the trials, it was observed that the addition of sulfamic acid to the composition above the optimum stoichiometric amount did not significantly impact the stability of the composition. Surprisingly, it was observed that when sulfamic acid was used below the stoichiometric amount, the composition almost always performed more poorly than the control with no sulfamic acid. The results of the stability trials is summarized in Table 22. The compositions listed in Table 22 are those containing the stoichiometric amount of sulfamic acid.

TABLE 22
Stabilized Chloroalkaline Detergent Compositions-Summary

| Chloro Alkaline Detergent | Available | | Duration | | | Improvement |
|---|---|---|---|---|---|---|
| Compositions | Cl % | Alkalinity | Days | Temperature ° C. | Cl Loss (Control) % | % Cl Lost |
| Detergent Composition I | 4.00 | Standard | 368 | 25 | 24 (75) | 51 |
| | | | | 40 | 17 (Depleted in 200 days) | 100 |
| | | | | 50 | 73 (Depleted in 60 days) | 100 |
| Detergent Composition I | 3.00 | Standard | 309 | 25 | 15 (72) | 57 |
| | | | | 40 | 15 (Depleted in 220 days) | 100 |
| Detergent Composition I | 3.00 | Adjusted | 299 | 25 | 22 (72) | 50 |
| | | | | 40 | 28 (Depleted in 200 days) | 100 |
| Detergent Composition I | 3.50 | Adjusted | 206 | 25 | 8 (69) | 61 |
| | | | | 40 | 22 (99) | 77 |
| Detergent Composition II | 4.00 | Standard | 368 | 25 | 19 (57) | 38 |
| | | | | 40 | 19 (99) | 80 |
| | | | | 50 | 50 (Depleted in 140 days) | 100 |
| Detergent Composition II | 3.00 | Standard | 297 | 25 | 14 (50) | 36 |
| | | | | 40 | 15 (93) | 78 |
| Detergent Composition II | 3.00 | Adjusted | 299 | 25 | 14 (50) | 36 |
| | | | | 40 | 13 (92) | 79 |
| Detergent Composition III | 3.00 | Adjusted | 138 | 25 | 15 (50) | 35 |
| | | | | 40 | 24 (91) | 67 |
| Detergent Composition IV | 2.00 | Standard | 368 | 25 | 30 (65) | 35 |
| | | | | 40 | 36 (97) | 61 |
| | | | | 50 | 64 (Depleted in 180 days) | 100 |
| Detergent Composition V | 3.50 | Standard | 299 | 25 | 13 (64) | 51 |
| | | | | 40 | 18 (Depleted in 250 days) | 100 |

### Stability of Chlorine Bleach in Various Surfactants

Organic substances such as surfactants, fragrances and colorants are very susceptible to oxidation by oxidants like bleach, especially chlorine bleach. These organic substances have oxidizable organic chromophores or functional groups that are very prone to oxidation by chlorine bleach. Thus, it is very difficult to formulate chlorine bleach compositions including these types of organic compounds.

In this trial, several surfactants such as amine oxides, phenyl ether disulfonates and alkyl polyglucosides, all commonly used in cleaning formulations, have been incorporated into detergent compositions 1 and 11 as shown in Tables 23 and 25. Sodium hypochlorite loss was very significant in the non-stabilized control compositions (i.e., those compositions comprising no sulfamic acid). The bleach stability of composition 1 and 11 was monitored and the stability data shown for up to 48 and 49 days, respectively, at 25° C. and 40° C. The results of the stability tests are shown in Tables 24 and 26.

TABLE 23
Stabilized Liquid Detergent I Composition with Various Surfactants with 3.2% Available Chlorine

| Ingredients | I (34) | I (35) | I (36) | I (37) | I (38) | I (39) | I (40) | I (41) |
|---|---|---|---|---|---|---|---|---|
| Deionized Water | 29.00 | 24.80 | 29.00 | 24.80 | 29.00 | 24.80 | 29.00 | 24.80 |
| Sodium Polyacrylate (50%) | 0.80 | 0.80 | 0.80 | 0.80 | 0.80 | 0.80 | 0.80 | 0.80 |
| 2-Phosphonobutane 1,2,4-Tricarboxylic acid (50%) | 1.20 | 1.20 | 1.20 | 1.20 | 1.20 | 1.20 | 1.20 | 1.20 |
| NaOH 50% | 36.80 | 36.80 | 36.80 | 36.80 | 36.80 | 36.80 | 36.80 | 36.80 |
| Sulfamic Acid | 0.00 | 4.20 | 0.00 | 4.20 | 0.00 | 4.20 | 0.00 | 4.20 |
| NaOCl (Av. Cl 10.6%) | 30.20 | 30.20 | 30.20 | 30.20 | 30.20 | 30.20 | 30.20 | 30.20 |
| Surfactants Incorporated | | | | | | | | |
| Dedecyldimethylamine Oxide (30%), Ammonyx DO | 2.00 | 2.00 | | | | | | |
| Octyldimethylamine Oxide (41%), Mackamine C8 | | | 2.00 | 2.00 | | | | |
| Decyl polygucoside (50%), Plantaren 2000N | | | | | 2.00 | 2.00 | | |
| C10-Alkyldiphenyloxide disulfonates (45%), Dowfax 3B2 | | | | | | | 2.00 | 2.00 |
| | 100 | 100 | 100 | 100 | 100 | 100 | 100 | 100 |
| Phase | Clear | Clear | Clear | Clear | Clear | Clear | Clear | Clear |
| pH (Neat) | 13.4 | 14.08 | 13.94 | 14.33 | 13.81 | 13.82 | 14.37 | 13.81 |
| T° C. | 20.8 | 20.08 | 20.80 | 20.8 | 20.6 | 20.9 | 20.9 | 21.1 |
| Viscosity (25° C., 30 rpm) cps | 11.3 | 12.3 | 6.14 | 7.07 | 9.92 | 10.3 | 6.02 | 6.86 |

TABLE 24
Stabilized Liquid Detergent I Composition with Various Surfactants - Bleach Stability Data

| | | | | | | % | | | % | | % | | % | | % |
|---|---|---|---|---|---|---|---|---|---|---|---|---|---|---|---|
| Sample | NH₂SO₂H | Storage | Time | % | Time | Av. | Phase | Time | Av. | Time | Av. | Time | Av. | % Cl | Improve- |
| ID | (%) | Temp | (Days) | Av. Cl | (Days) | Cl | Stability | (Days) | Cl | (Days) | Cl | (Days) | Cl | Lost | ment |
| I (34) | Control | 25° C. | 0 | 3.106 | 5 | 2.845 | OK | 21 | 2.462 | 38 | 2.149 | 48 | 2.015 | 35.13 | |
| I (35) | 4.2 | 25° C. | 0 | 3.075 | 5 | 2.981 | OK | 21 | 2.901 | 38 | 2.861 | 48 | 2.858 | 7.06 | 28 |
| I (36) | Control | 25° C. | 0 | 3.075 | 5 | 2.791 | OK | 21 | 2.331 | 38 | 2.027 | 48 | 1.897 | 38.31 | |
| I (37) | 4.2 | 25° C. | 0 | 3.021 | 5 | 2.893 | OK | 21 | 2.689 | 38 | 2.611 | 48 | 2.569 | 14.96 | 23 |
| I (38) | Control | 25° C. | 0 | 3.129 | 5 | 1.357 | Separated | 21 | 0.429 | 38 | 0.136 | 48 | 0.038 | 98.79 | |
| I (39) | 4.2 | 25° C. | 0 | 3.049 | 5 | 1.863 | Separated | 21 | 1.399 | 38 | 1.214 | 48 | 1.166 | 61.76 | 38 |
| I (40) | Control | 25° C. | 0 | 3.131 | 5 | 2.922 | OK | 21 | 2.383 | 38 | 2.010 | 48 | 1.851 | 40.88 | |
| I (41) | 4.2 | 25° C. | 0 | 3.124 | 5 | 3.054 | OK | 21 | 2.958 | 38 | 3.002 | 48 | 2.959 | 5.28 | 36 |
| I (34) | Control | 40° C. | 0 | 3.106 | 6 | 2.058 | OK | 21 | 1.055 | 38 | 0.690 | 48 | 0.537 | 82.71 | |
| I (35) | 4.2 | 40° C. | 0 | 3.075 | 6 | 2.899 | OK | 21 | 2.803 | 38 | 2.093 | 48 | 2.670 | 13.17 | 60 |
| I (36) | Control | 40° C. | 0 | 3.075 | 6 | 1.935 | OK | 21 | 1.000 | 38 | 0.648 | 48 | 0.450 | 85.37 | |
| I (37) | 4.2 | 40° C. | 0 | 3.021 | 6 | 2.649 | OK | 21 | 2.460 | 38 | 2.421 | 48 | 2.364 | 21.75 | 63 |
| I (38) | Control | 40° C. | 0 | 3.129 | 6 | 0.112 | Separated | 21 | 0.008 | 38 | 0.005 | 48 | 0 | 100.0 | |
| I (39) | 4.2 | 40° C. | 0 | 3.049 | 6 | 1.510 | Separated | 21 | 0.976 | 38 | 0.844 | 48 | 0.830 | 72.78 | 27 |
| I (40) | Control | 40° C. | 0 | 3.131 | 6 | 2.014 | OK | 21 | 0.960 | 38 | 0.589 | 48 | 0.368 | 88.25 | |
| I (41) | 4.2 | 25° C. | 0 | 3.124 | 6 | 3.008 | OK | 21 | 2.946 | 38 | 2.969 | 48 | 2.695 | 7.33 | 81 |

TABLE 25
Stabilized Liquid Detergent II Composition with Various Surfactants with 3.0% Available Chlorine

| Ingredients | I (25) | I (26) | I (27) | I (28) | I (29) | I (30) | I (31) | I (32) |
|---|---|---|---|---|---|---|---|---|
| Deionized Water | 40.24 | 36.14 | 40.24 | 36.14 | 40.24 | 36.14 | 40.24 | 36.14 |
| Sodium Glucoheptonate | 0.06 | 0.06 | 0.06 | 0.06 | 0.06 | 0.06 | 0.06 | 0.06 |
| Sodium Tripolyphosphate LD | 5.00 | 5.00 | 5.00 | 5.00 | 5.00 | 5.00 | 5.00 | 5.00 |
| KOH 45% | 24.40 | 24.40 | 24.40 | 24.40 | 24.40 | 24.40 | 24.40 | 24.40 |
| Sulfamic Acid | 0.00 | 4.10 | 0.00 | 4.10 | 0.00 | 4.10 | 0.00 | 4.10 |
| NaOCl (Av. Cl 10.6%) | 28.30 | 28.30 | 28.30 | 28.30 | 28.30 | 28.30 | 28.30 | 28.30 |
| Surfactants Incorporated | | | | | | | | |
| Dedecyldimethylamine Oxide (30%), Ammonyx DO | 2.00 | 2.00 | | | | | | |
| Octyldimethylamine Oxide (41%), Mackamine C8 | | | 2.00 | 2.00 | | | | |
| Decyl polygucoside (50%), Plantaren 2000N | | | | | 2.00 | 2.00 | | |
| C10-Alkyldiphenyloxide disulfonates (45%), Dowfax 3B2 | | | | | | | 2.00 | 2.00 |
| | 100 | 100 | 100 | 100 | 100 | 100 | 100 | 100 |
| pH (Neat) | 14.1 | 14.12 | 14.14 | 14.13 | 14.162 | 14.14 | 14.13 | 14.17 |
| T° C. | 22.9 | 23.4 | 23.1 | 23 | 22 | 22.1 | 22.5 | 23 |
| Phase | | Cloudy | | | | | Cloudy | |
| Viscosity (25° C., 30 rpm) cps | 2.38 | 2.54 | 2.42 | 2.62 | 3.16 | 3.62 | 2.40 | 2.50 |

TABLE 26
Stabilized Liquid Detergent II Composition with Various Surfactants - Bleach Stability Data

| | | | | | | % | | | % | | % | | | | % |
|---|---|---|---|---|---|---|---|---|---|---|---|---|---|---|---|
| Sample | NH₂SO₂H | Storage | Time | % | Time | Av. | | Time | Av. | Time | Av. | Time | % | % Cl | Improve- |
| ID | (%) | Temp | (Days) | Av. Cl | (Days) | Cl | Stability | (Days) | Cl | (Days) | Cl | (Days) | Av. Cl | Lost | ment |
| I (25) | Control | 25° C. | 0 | 3.019 | 6 | 2.828 | OK | 22 | 2.659 | 32 | 2.551 | 49 | 2.451 | 18.81 | |
| I (26) | 4.1 | 25° C. | 0 | 2.934 | 6 | 2.790 | OK | 22 | 2.685 | 32 | 2.615 | 49 | 2.612 | 10.97 | 8 |
| I (27) | Control | 25° C. | 0 | 3.021 | 6 | 2.736 | OK | 22 | 2.567 | 32 | 2.415 | 49 | 2.314 | 23.40 | |
| I (28) | 4.1 | 25° C. | 0 | 2.939 | 6 | 2.722 | OK | 22 | 2.586 | 32 | 2.538 | 49 | 2.515 | 14.43 | 9 |
| I (29) | Control | 25° C. | 0 | 3.017 | 6 | 1.772 | Separated | 22 | 0.824 | 32 | 0.597 | 49 | 0.347 | 88.50 | |
| I (30) | 4.1 | 25° C. | 0 | 2.904 | 6 | 2.498 | OK | 22 | 2.062 | 32 | 1.964 | 49 | 1.889 | 34.95 | 54 |
| I (31) | Control | 25° C. | 0 | 3.019 | 6 | 2.812 | OK | 22 | 2.612 | 32 | 2.496 | 49 | 2.348 | 22.23 | |
| I (32) | 4.1 | 25° C. | 0 | 2.899 | 6 | 2.807 | OK | 22 | 2.776 | 32 | 2.786 | 49 | 2.730 | 5.83 | 16 |
| I (25) | Control | 40° C. | 0 | 3.019 | 6 | 2.367 | OK | 14 | 2.057 | 32 | 1.513 | 49 | 1.231 | 59.22 | |
| I (26) | 4.1 | 40° C. | 0 | 2.934 | 6 | 2.551 | OK | 14 | 2.415 | 32 | 2.211 | 49 | 2.050 | 30.13 | 29 |
| I (27) | Control | 40° C. | 0 | 3.021 | 6 | 2.317 | OK | 14 | 1.964 | 32 | 1.462 | 49 | 1.134 | 62.46 | |
| I (28) | 4.1 | 40° C. | 0 | 2.939 | 6 | 2.509 | OK | 14 | 2.345 | 32 | 2.119 | 49 | 1.948 | 33.72 | 29 |
| I (29) | Control | 40° C. | 0 | 3.017 | 6 | 0.213 | Cloudy | 14 | 0.032 | 32 | 0.009 | 49 | 0.022 | 99.27 | |
| I (30) | 4.1 | 40° C. | 0 | 2.904 | 6 | 1.928 | Cloudy | 14 | 1.736 | 32 | 1.501 | 49 | 1.369 | 52.86 | 46 |
| I (31) | Control | 40° C. | 0 | 3.019 | 6 | 2.301 | OK | 14 | 1.927 | 32 | 1.382 | 49 | 1.049 | 65.25 | |
| I (32) | 4.1 | 25° C. | 0 | 2.899 | 6 | 2.709 | OK | 14 | 2.626 | 32 | 2.552 | 49 | 2.447 | 15.59 | 49 |

As shown in the preceding tables, a bleach stability improvement of up to 38% for composition 1 and 54% for composition II at 25° C. was achieved. At 40° C., the improvement over the control was even greater: up to 81% for composition 1 and 49% for composition II. Similar bleach stability improvement is also expected when fragrances as well as colorants and dyes are incorporated in bleach stabilizing formulations according to the present invention.

### Chlorine Bleach Stabilization Manufacturing Pilot Run

Several pilot batches of sulfamic acid stabilized bleaching compositions of Liquid Detergent I with adjusted alkalinity and varied available chlorine were made as shown in Table 27. The compositions were then stored in large and small containers (250 gal. and 15 gal.) under both sunny and shady conditions. The bleach stability of the composition is shown in Table 28. There is a very significant improvement in bleach stability of the stabilized product over the control when stored in a large container and kept in the sun. In 3 months of storing at about 77° F. in the sun and in a 250-gallon container, a chlorine stability of 100% improvement was achieved.

TABLE 27
Chlorine Bleach Stabilization Technology - Production Pilot Run

| | Detergent I | Detergent I | Detergent I | Detergent I | Detergent I | Detergent I | Detergent I |
|---|---|---|---|---|---|---|---|
| | Standard | Stabilized | Stabilized/Adj. | Stabilized | Stabilized/Adj. | Stabilized | Stabilized/Adj. |
| | 4.15% Av. | 4.15% Av. | Alkali | 3.75% Av. | Alkali | 3.50% Av. | Alkali |
| Ingredients | Cl | Cl | 4.15% Av. Cl | Cl | 3.75% Av. Cl | Cl | 3.50% Av. Cl |
| Soft Water | 33.45 | 26.30 | 21.85 | 28.57 | 24.55 | 30.95 | 27.20 |
| 2-Phosphonobutane-1,2,4- | 1.20 | 1.20 | 1.20 | 1.20 | 1.20 | 1.20 | 1.20 |
| Tricarboxylic Acid (50%) | | | | | | | |
| Caustic Soda (50%) | 33.30 | 33.30 | 37.75 | 33.30 | 37.32 | 33.30 | 37.05 |
| Sodium Polyacrylate (50%), | 0.80 | 0.80 | 0.80 | 0.80 | 0.80 | 0.80 | 0.80 |
| Good Rite 7058 | | | | | | | |
| Sodium Hypochlorite (12%) | 31.25 | 33.00 | 33.00 | 31.25 | 31.25 | 29.20 | 29.20 |
| Sulfamic Acid | 0.00 | 5.40 | 5.40 | 4.88 | 4.88 | 4.55 | 4.55 |

TABLE 28
Chlorine Bleach Stabilization Technology - Production Pilot Run; Bleach Stability in Sun
and Shade Temperature in Different Container

| Storage | Sun/250 Gallon | | Shade/250 Gallon | | Sun/15 Gallon | | Shade/15 Gallon | |
|---|---|---|---|---|---|---|---|---|
| Conditions | Container | | Container | | Container | | Container | |
| Time (Days) | Av. Cl (%) | % Cl Lost | Av. Cl (%) | % Cl Lost | Av. Cl (%) | % Cl Lost | Av. Cl (%) | % Cl Lost |

Liquid Detergent I - Control (Plant Trial) with 4.15% Cl

| | | | | | | | | |
|---|---|---|---|---|---|---|---|---|
| 0 | 4.15 | 0.00 | 4.15 | 0.00 | 4.15 | 0.00 | 4.15 | 0.00 |
| 4 | 3.88 | 6.51 | 4.14 | 0.24 | 4.12 | 0.72 | 4.14 | 0.24 |
| 10 | 3.67 | 11.57 | 4.01 | 3.37 | 4.03 | 2.89 | 4.15 | 0.00 |
| 17 | 2.85 | 31.33 | 3.93 | 5.30 | 3.9 | 6.02 | 4.07 | 1.93 |
| 23 | 2.17 | 47.71 | 3.89 | 6.27 | 3.7 | 10.84 | 4.04 | 2.65 |
| 31 | 1.45 | 65.06 | 3.76 | 9.40 | 3.52 | 15.18 | 3.87 | 6.75 |
| 38 | 0.99 | 74.48 | 3.63 | 12.32 | 3.41 | 17.23 | 3.80 | 8.21 |
| 52 | 0.31 | 92.53 | 3.61 | 13.01 | 3.18 | 23.37 | 3.57 | 13.98 |
| 66 | 0.12 | 97.11 | 3.49 | 15.90 | 2.85 | 31.33 | 3.58 | 13.73 |
| 80 | 0.07 | 98.31 | 3.21 | 22.65 | 2.26 | 45.54 | 3.28 | 20.96 |
| 93 | 0.07 | 98.31 | 3.05 | 26.51 | 2.15 | 48.19 | 3.17 | 23.61 |
| 107 | 0.06 | 98.55 | 2.93 | 29.40 | 1.79 | 56.87 | 2.94 | 29.16 |
| 149 | 0.08 | 98.07 | 2.23 | 46.27 | 1.20 | 71.08 | 2.35 | 43.37 |
| 180 | 0.07 | 98.31 | 2.00 | 51.81 | 1.00 | 75.90 | 2.05 | 50.60 |
| 208 | 0.08 | 98.07 | 1.77 | 57.35 | 0.77 | 81.45 | 1.76 | 57.59 |

Liquid Detergent I - Stabilized (Plant Trial) with 3.2% Cl

| | | | | | | | | |
|---|---|---|---|---|---|---|---|---|
| 0 | 3.36 | 0.00 | 3.36 | 0.00 | 3.36 | 0.00 | 3.36 | 0.00 |
| 3 | 3.09 | 8.04 | 3.03 | 9.82 | 3.03 | 9.82 | 3.03 | 9.82 |
| 8 | 2.94 | 12.50 | 2.91 | 13.39 | 2.92 | 13.10 | 2.94 | 12.50 |
| 14 | 2.85 | 15.18 | 2.87 | 14.58 | 2.82 | 16.07 | 2.91 | 13.39 |
| 21 | 2.76 | 17.86 | 2.8 | 16.67 | 2.72 | 19.05 | 2.84 | 15.48 |
| 28 | 2.78 | 17.26 | 2.74 | 18.45 | 2.74 | 18.45 | 2.78 | 17.26 |
| 36 | 2.77 | 17.56 | 2.76 | 17.86 | 2.68 | 20.24 | 2.78 | 17.26 |
| 50 | 2.79 | 16.96 | 2.73 | 18.75 | 2.67 | 20.54 | 2.74 | 18.45 |
| 64 | 2.71 | 19.35 | 2.75 | 18.15 | 2.65 | 21.13 | 2.70 | 19.64 |
| 78 | 2.76 | 17.86 | 2.74 | 18.45 | 2.68 | 20.24 | 2.72 | 19.05 |
| 91 | 2.68 | 20.24 | 2.74 | 18.45 | 2.63 | 21.73 | 2.70 | 19.64 |
| 105 | 2.62 | 22.02 | 2.75 | 18.15 | 2.60 | 22.62 | 2.74 | 18.45 |
| 149 | 2.64 | 21.43 | 2.76 | 17.86 | 2.62 | 22.02 | 2.70 | 19.64 |
| 180 | 2.60 | 22.62 | 2.76 | 17.86 | 2.50 | 25.60 | 2.70 | 19.64 |
| 208 | 2.58 | 23.21 | 2.78 | 17.26 | 2.38 | 29.17 | 2.68 | 20.24 |

We claim:

1. A liquid, shelf-stable, aqueous alkaline cleaning composition with chlorine bleach comprising:
a chlorine bleach capable of forming a hypochlorite in water;
a bleach stabilizer selected from the group consisting of compounds having at least one NH— or NH₂— moiety capable of reacting with said hypochlorite to form NCl—, NHCl— or NCl₂— compounds; and
from about 5-50% by weight of a metal hydroxide;
said composition having a pH of at least about 11.5.

2. The composition of claim 1, said chlorine bleach selected from the group consisting of alkali metal hypochlorites, alkaline earth metal hypochlorites, chlorine gas, hypochlorous acid, chlorine dioxide, N-chloro melamines, 1,3-dichloro-5,5-dimethylhydantoin, N-chlorosuccinimide, N,chloro-N-sodiobenzene sulfonamide, N-chloro hydantoins, N-chlorinated isocyanurates, N-chlorinated cyanuric acids, and combinations thereof.

3. The composition of claim 2, said chlorine bleach being sodium hypochlorite.

4. The composition of claim 1, said composition comprising a sufficient quantity of chlorine bleach to provide from about 0.1-10% by weight of available chlorine.

5. The composition of claim 4, wherein said composition loses less than about 60% of said available chlorine after storage of said composition for 8 months at 25° C.

6. The composition of claim 1, the molar ratio of bleach stabilizer to chlorine bleach being at least about one mole of chlorine per mole of active hydrogen attached to the at least one nitrogen atom of said bleach stabilizer.

7. The composition of claim 1, said bleach stabilizer being selected from the group consisting of sulfamic acids and the corresponding metal salts thereof, alkyl sulfamates, cycloalkyl sulfamates, aryl sulfamates, alkyl sulfonamides, aryl sulfonamides, sulfamide, carbamate, methyl carbamate, methane sulfonamide, benzene sulfonamide, p-toluene sulfonamide, benzamide, phenyl sulfinimide, diphenyl sulfonamide, phenylsulfinimidylamide, diphenyl sulfonamide, dimethyl sulfinimidylamine, succinimide, acetamide, phthalimide, acetanilide, formamide, N-methylformamide, dicyanadiamide, N-ethylacetamide and 4-carboxybenzene sulfonamide, melamine, cyanamide, dicyanamide, ethyl carbamate, urea, thiourea, N-methylurea, N-methylolurea, acetylurea, isocyanuric acid, barbituric acid, 6-methyl uracil, glycoluril, caprolactum, dimethylhydantoin, imidazoline, pyrrolidone, pyrole, indole, orthophosphoryl triamide, phosphoryl triamide boric acid amide, and combinations thereof.

8. The composition of claim 7, said bleach stabilizer being sulfamic acid or an alkali or alkaline earth metal salt thereof.

9. The composition of claim 1, said metal hydroxide being an alkali or alkaline earth metal hydroxide.

10. The composition of claim 1, said composition having a pH of at least about 12.

11. The composition of claim 10, said composition having a pH of between about 12.5-14.

12. The composition of claim 1, said composition having a viscosity of less than about 2000 cps.

13. The composition of claim 12, said composition having a viscosity of less than about 1000 cps.

14. The composition of claim 1, said composition comprising up to about 20% by weight of an inorganic or organic sequestrant.

15. The composition of claim 14, said sequestrant being a non-cross-linked polyacrylate having a molecular weight of about 1,000-100,000.

16. The composition of claim 1, said composition comprising up to about 25% by weight of an inorganic or organic builder salt.

17. The composition of claim 16, said builder salt being selected from the group consisting of alkali metal phosphates, alkali metal phosphonates, alkali metal pyrophosphates, alkali metal tripolyphosphates, alkali metal metaphosphates, alkali metal borates, alkali metal carbonates, alkali metal bicarbonates, crystalline and amorphous water insoluble aluminosilicates, alkali metal salts of polycarboxylic acids, alkali metal salts of nitriloacetic acids, and combinations thereof.

18. The composition of claim 1, said composition comprising up to about 6% by weight of a surface active agent.

19. The composition of claim 18, said surface active agent being selected from the group consisting of anionic, nonionic, cationic and amphoteric surfactants, and mixtures thereof.

20. A liquid, shelf-stable, aqueous alkaline cleaning composition with chlorine bleach comprising:
a quantity of chlorine bleach capable providing from about 0.1-10% by weight of available chlorine;
a bleach stabilizer selected from the group consisting of sulfamic acid or an alkali or alkaline earth metal salt thereof, the molar ratio of bleach stabilizer to chlorine bleach being at least about one mole of active hydrogen attached to the at least one nitrogen atom of said bleach stabilizer per mole of chlorine; and
from about 5-50% by weight of an alkali or alkaline earth metal hydroxide, said composition having a pH of at least about 11.5.

21. The composition of claim 20, said composition having a pH of at least about 12.

22. The composition of claim 21, said composition having a pH of between about 12.5-14.

23. The composition of claim 20, said composition having a viscosity of less than about 2000 cps.

24. The composition of claim 23, said composition having a viscosity of less than about 1000 cps.

25. The composition of claim 20, said chlorine bleach being selected from the group consisting of alkali metal hypochlorites, alkaline earth metal hypochlorites, chlorine gas, hypochlorous acid, chlorine dioxide, N-chloro melamines, 1,3-dichloro-5,5-dimethylhydantoin, N-chlorosuccinimide, N,chloro-N-sodiobenzene sulfonamide, N-chloro hydantoins, N-chlorinated isocyanurates, N-chlorinated cyanuric acids, and combinations thereof.

26. The composition of claim 20, said composition comprising up to about 20% by weight of an inorganic or organic sequestrant.

27. The composition of claim 20, said composition comprising up to about 25% by weight of an inorganic or organic builder salt.

28. The composition of claim 20, said composition comprising up to about 6% by weight of a surface active agent.

29. The composition of claim 20, wherein said composition loses less than about 60% of said available chlorine after storage of said composition for 8 months at 25° C.

30. A method of cleaning a soiled surface comprising the steps of:
(a) providing a composition according to claim 1; and
(b) applying said composition to said surface.

31. The method of claim 30, said method further comprising:
(c) forming a use solution by adding from about 1-500 parts by weight water to said composition prior to application to said surface.

32. The method of claim 31, step (c) comprising forming a use solution formed by adding to said composition from about 25-100 parts by weight water.

33. The method of claim 31, the water in step (c) having a temperature between about 40-90° C.

34. The method of claim 30, said surface being soiled with milk or a food product.

35. The method of claim 30, said surface comprising a surface of a food processing system or a surface of a clean-in-place system.

36. A liquid alkaline cleaning composition with chlorine beach use solution comprising:
about one part by weight of the composition of claim 1; and
from about 1-500 parts by weight water,
said use solution having a pH of at least about 11.5.

37. A liquid alkaline cleaning composition with chlorine beach use solution comprising:
about one part by weight of the composition of claim 20; and
from about 1-500 parts by weight water,
said use solution having a pH of at least about 11.5.
